(19) United States
(12) Patent Application Publication
(10) Pub. No.: US 2013/0293611 A1
(43) Pub. Date: Nov. 7, 2013

(54) IMAGE RECORDING APPARATUS AND METHOD

(71) Applicant: FUJIFILM CORPORATION, Tokyo (JP)

(72) Inventor: Masashi UESHIMA, Kanagawa (JP)

(73) Assignee: Fujifilm Corporation, Tokyo (JP)

(21) Appl. No.: 13/874,226

(22) Filed: Apr. 30, 2013

(30) Foreign Application Priority Data
May 7, 2012 (JP) 2012-106158

(51) Int. Cl. B41J 2/125

(52) U.S. Cl. CPC B41J 2/125
USPC 347/12

(57) ABSTRACT

According to the image recording apparatus and method of the present invention, as a defective recording element is detected immediately before a correction value is generated, while a correction value is being generated, and before an image is recorded, management of the recording elements can be ensured than before. In particular, as the detection of a defective recording element is carried out immediately before a correction value is generated, a defective recording element becomes known at the time of generating the correction value, and the correction value can be generated in a state where the defective recording element is put in a non-ejecting state. Further, a defective recording element can be detected more reliably. Through this, generation of a non-uniform streak resulting from a defective recording element can be suppressed with a higher possibility than before. As a result, an image of higher quality than before can be formed.

### BACKGROUND OF THE INVENTION

1. Field of the Invention

The present invention relates to image recording apparatuses and image recording methods for correcting non-uniformity in an image resulting from recording characteristics of a recording element.

2. Description of the Related Art

In an inkjet recording apparatus in which ink is ejected from a plurality of ink ejection nozzles (hereinafter, simply referred to as a nozzle) to form an image on a recording medium, density non-uniformity (density unevenness) may be produced in a recorded image due to a variation in ejection characteristics (recording characteristics) of each nozzle in an inkjet head (a recording head). In order to correct such density non-uniformity, a density non-uniformity correction test chart is outputted, and a density correction table (a correction value) for each of the nozzles is then obtained from ejection characteristics of each nozzle that have been obtained by analyzing the stated test chart. Then, an image signal is corrected in accordance with this density correction table to control an ink ejection of each nozzle (see Japanese Patent Application Laid-Open No. 2010-82989).

Furthermore, with an inkjet recording apparatus, as time elapses, ejection characteristics vary among nozzles due to ink in a nozzle opening being dried or the like. As a result, as shown in FIG. 30A, a deteriorated nozzle that adversely affects ejection of ink, a non-ejecting nozzle N(E) that cannot eject ink at all, or the like is generated. Through this, as shown in FIG. 30B, when a recorded image is observed, a single non-uniform streak (a white streak, hereinafter, simply referred to as a non-uniform streak) WL resulting from the non-ejecting nozzle N(E) is generated. Accordingly, a technique for preventing non-uniformity in a recorded image resulting from a non-ejecting nozzle N(E) is being proposed.

For example, with an inkjet recording apparatus according to Japanese Patent Application Laid-Open No. 2011-201121, a non-uniform streak correction test chart is outputted, and a correction parameter for correcting a non-uniform streak is obtained from ejection characteristics of each nozzle that have been obtained by analyzing the stated test chart. Then, an image signal is corrected in accordance with this non-uniform streak correction parameter to control ink ejection of each nozzle. To be more specific, as shown in FIG. 31A, by increasing ink output density of adjacent nozzles N(A) that are adjacent to a non-ejecting nozzle N(E), the non-uniform streak is corrected, as shown in FIG. 31B.

As described above, with the inkjet recording apparatuses according to Japanese Patent Application Laid-Open No. 2010-82989 and Japanese Patent Application Laid-Open No. 2011-201121, image processing parameters such as the density correction table and the non-uniform streak correction parameter are obtained in a state where a malfunctioning nozzle such as the non-ejecting nozzle has been generated, and thus an image processing parameter that is optimal in this state is obtained. However, when an image is to be formed on a recording medium (image data are outputted), it is not necessarily that the inkjet head is retained in the same state as that of the time when the image processing parameter has been obtained. For example, a nozzle that is in a non-ejecting state when an image processing parameter is obtained may enter an ejectable state. In such a case, carrying out correction based on the image processing parameter leads to overcorrection as shown in FIGS. 32A and 32B, and an overcorrection non-uniform streak (a black streak) WK is generated.

Accordingly, with an inkjet recording apparatus described in Japanese Patent Application Laid-Open No. 2011-73285, a malfunctioning nozzle such as a non-ejecting nozzle is detected when acquiring an image processing parameter to carry out non-ejection correction processing to cause the malfunctioning nozzle to stop ejecting ink. Through this, even if the nozzle that has been in a non-ejecting state enters an ejectable state, ejection of ink from this nozzle does not occur, and thus generation of an overcorrection non-uniform streak is prevented.

### SUMMARY OF THE INVENTION

However, with the inkjet recording apparatus according to Japanese Patent Application Laid-Open No. 2011-73285, although a malfunctioning nozzle is detected when a test chart is outputted to acquire an image processing parameter, it is yet unclear as to whether the malfunctioning nozzle is detected before or after the test chart is outputted. Therefore, in the inkjet recording apparatus according to Japanese Patent Application Laid-Open No. 2011-73285, it is unclear as to whether a malfunctioning nozzle has been included in the nozzles of the inkjet head when the test chart has been outputted. When density non-uniformity correction or non-uniform streak correction is carried out using a test chart that has been generated in a state where nozzle management is not ensured as in the above, there is a risk in that a non-uniform streak (a black streak, a white streak) is generated.

Furthermore, there may be a nozzle in an inkjet head that is in an ejectable state when an image processing parameter is acquired but enters a non-ejectable state at a later time when an image is to be recorded. With the inkjet recording apparatus according to Japanese Patent Application Laid-Open No. 2011-73285, although a malfunctioning nozzle is detected when an image processing parameter is acquired, a malfunctioning nozzle that is generated after the image processing parameter is acquired, in particular, an unstable malfunctioning nozzle that may enter a state where ink cannot be ejected continuously may not be detected reliably. Accordingly, with the inkjet recording apparatus according to Japanese Patent Application Laid-Open No. 2011-73285, since the nozzle management is not ensured, there is a risk in that a non-uniform streak (a white streak) resulting from a malfunctioning nozzle (a non-ejecting nozzle) that has not been detected is generated. Such a problem that a malfunctioning nozzle cannot reliably be detected also occurs in the inkjet recording apparatus according to Japanese Patent Application Laid-Open No. 2011-201121.

An object of the present invention is to provide an image recording apparatus and an image recording method that can reliably prevent generation of a non-uniform streak (a black streak, a white streak).

An image recording apparatus for achieving the aforementioned object of the present invention includes: an image recording device that records an image on a recording medium with a recording head having a plurality of recording elements while moving the recording head and the recording medium relative to each other; a correction value generation device that acquires characteristic information indicative of recording characteristics of the plurality of recording elements to generate, based on the characteristic information, a correction value for correcting an output of recording elements that are included in the plurality of recording elements and are to be used to correct non-uniformity in the image resulting from the recording characteristics; a first defective recording element detection device that detects a defective recording element among the plurality of recording elements immediately before the correction value is generated by the correction value generation device; a second defective recording element detection device that carries out detection of a defective recording element in a period after the detection of the defective recording element by the first defective recording element detection device and while the correction value is being generated by the correction value generation device; a third defective recording element detection device that carries out detection of a defective recording element in a period after the detection of the defective recording element by the second defective recording element detection device and at least before an image is recorded; a stopping device that, when defective recording elements are detected respectively by the first defective recording element detection device, the second defective recording element detection device, and the third defective recording element detection device, causes an output from the detective recording elements to stop; and an output correction device that corrects the output of the recording elements other than the defective recording elements based on the correction value.

According to the present invention, since the detection of the defective recording element is carried out immediately before the correction value is generated, while the correction value is being generated, and before the image is recorded, management of the recording elements can be ensured than before.

It is preferable that, when a defective recording element is detected by the first defective recording element detection device, the stopping device causes the output from the defective recording element to stop before the characteristic information is acquired by the correction value generation device. Through this, the correction value can be generated in a state where the defective recording element is put in a non-ejecting state.

It is preferable that a memory device is further provided to store defective recording element information that pertains to the defective recording elements detected respectively by the first defective recording element detection device, the second defective recording element detection device, and the third defective recording element detection device, and that the stopping device causes the output from the defective recording element to stop based on the defective recording element information stored in the memory device. Storing information on the defective recording elements detected respectively by the defective recording element detection devices makes it possible to prevent the defective recording elements from outputting.

It is preferable that the memory device separately stores defective recording element information pieces that respectively pertain to the defective recording elements detected respectively by the first defective recording element detection device, the second defective recording element detection device, and the third defective recording element detection device. Through this, the defective recording element information pieces that respectively pertain to the defective recording elements detected by the respective defective recording element detection devices can be differentiated from one another. Accordingly, a defective recording element information piece that pertains to a defective recording element detected by any one of the defective recording element detection devices can be selectively deleted.

It is preferable that a first information deletion device is further provided to, when a new correction value is to be generated by the correction value generation device, delete, from the memory device, the defective recording element information on the defective recording elements detected respectively by the first and second defective recording element detection devices when generating a previous instance of the correction value. Through this, output stop processing of a defective recording element can be carried out using the latest defective recording element information. Further, since an increase in the defective recording element information to be stored in the memory device can be suppressed, a memory capacity of the memory device can be reduced.

It is preferable that, each time a new defective recording element is detected by the first and second defective recording element detection devices as a new correction value is generated by the correction value generation device, the memory device additionally stores the defective recording element information that pertains to the defective recording element. Through this, each time a new defective recording element is detected by each of the defective recording element detection devices, the defective recording element information is accumulated in the memory device, and thus an output from a recording element that has been detected even once as a defective recording element stops. As a result, generation of non-uniformity in an image (a non-uniform streak) can be reduced.

It is preferable that a count device is further provided to count the number of defective recording elements based on the defective recording element information stored in the memory device, and that a warning display device is further provided to, when the number of the defective recording elements counted by the count device reaches a predetermined number, carry out a warning display to notify to that effect. Through this, even in a case where the number of the defective recording elements (the defective recording element information) becomes large as the defective recording element information is additionally stored, a user or the like can be notified to that effect.

It is preferable that a second information deletion device is further provided to, when a predetermined operation to execute detection of a defective recording element is carried out after the warning display by the warning display device, delete, from the memory device, the defective recording element information on the defective recording elements detected by the first and second defective recording element detection devices. Through this, since an increase in the defective recording element information to be stored in the memory device can be suppressed, a memory capacity of the memory device can be reduced.

It is preferable that the correction value generation device generates a plurality of types of correction values to respectively correct a plurality of types of non-uniformity, that the first defective recording element detection device carries out detection of a defective recording element immediately before each of the plurality of types of correction values is generated by the correction value generation device, and that the second defective recording element detection device carries out detection of a defective recording element while each of the plurality of types of correction values is being generated by the correction value generation device. Through this, a defective recording element can be detected more reliably.

It is preferable that the correction value generation device generates correction values respectively for a plurality of image recording conditions when an image is recorded on a recording medium, that the memory device stores the correction values for the respective image recording conditions generated by the correction value generation device and defective recording element information on the defective recording elements for the respective image recording conditions detected by the first and second defective recording element detection devices as the correction values are generated, the correction values and the defective recording element information being associated with each other, and is provided with an image recording condition selection device to select an image recording condition, that the stopping device causes an output from a defective recording element to stop based on the defective recording element information in the memory device corresponding to the image recording condition selected by the image recording condition selection device, and that the output correction device corrects the output of the recording elements other than the defective recording element based on the correction value in the memory device corresponding to the image recording condition. Through this, an image of higher quality can be formed.

It is preferable that the image recording condition selection device can select a plurality of image recording conditions, that the output correction device corrects the output of the recording elements other than the defective recording element based on the plurality of correction values that respectively correspond to the plurality of image recording conditions selected by the image recording condition selection device, and that the stopping device causes the output from the defective recording element to stop based on a combination of a plurality of pieces of defective recording element information that respectively correspond to the plurality of image recording conditions selected by the image recording condition selection device. Since a defective recording element whose output is to be stopped can be changed in accordance with a combination of image recording conditions to be used, an image of higher image quality can be formed.

It is preferable that the correction value generation device acquires, as the characteristic information, a read result of a first test chart that is recorded by recording elements other than the recording elements determined as pseudo-defective recording elements in a recording head and generates a first correction value based on the read result of the first test chart to correct an non-uniform streak in an image resulting from the defective recording element. Through this, a non-uniform streak in an image can be suppressed.

It is preferable that the correction value generation device acquires, as the characteristic information, a read result of a second test chart that is recorded by a recording head and that indicates recording density for each of the plurality of recording elements and generates a second correction value based on the read result of the second test chart to correct density non-uniformity in an image resulting from the recording characteristics of the plurality of recording elements. Through this, density non-uniformity in an image can be suppressed.

It is preferable that the first to third defective recording element detection devices carry out detection of a defective recording element based on a read result of a third test chart that is configured of a line pattern recorded for each of the plurality of recording elements. Through this, a determination for a defective recording element can be made for each of the plurality of recording elements.

It is preferable that the recording element is a nozzle to eject a droplet and that the defective recording element is a non-ejecting nozzle that cannot be used to record an image.

It is preferable that the recording head is a head of a single-pass type that records an image with a single relative movement with respect to the recording medium. This is because a defective recording element needs to be detected more reliably in the single-pass type than in a multi-pass type.

In addition, an image recording method for achieving the aforementioned object of the present invention is an image recording method to record an image on a recording medium with a recording head having a plurality of recording elements while moving the recording head and the recording medium relative to each other. The image recording method includes: a correction value generation step of acquiring characteristic information indicative of recording characteristics of the plurality of recording elements to generate, based on the characteristic information, a correction value for correcting an output of recording elements that are included in the plurality of recording elements and are to be used to correct non-uniformity in the image resulting from the recording characteristics; a first defective recording element detection step of detecting a defective recording element among the plurality of recording elements immediately before the correction value is generated in the correction value generation step; a second defective recording element detection step of carrying out detection of a defective recording element in a period after the detection of the defective recording element in the first defective recording element detection step and while the correction value is being generated in the correction value generation step; a third defective recording element detection step of carrying out detection of a defective recording element in a period after the detection of the defective recording element in the second defective recording element detection step and at least before an image is recorded; an output stopping step of, when defective recording elements are detected respectively in the first defective recording element detection step, the second defective recording element detection step, and the third defective recording element detection step, causing an output from the detective recording elements to stop, and an output correction step of correcting the output of the recording elements other than the defective recording elements based on the correction value.

According to this aspect, since the detection of a defective recording element is carried out when the correction value is generated and in a period after the correction value is generated and at least before the image is recorded, a malfunctioning nozzle can be detected reliably.

According to the image recording apparatus and method of the present invention, as a defective recording element is detected immediately before a correction value is generated, while a correction value is being generated, and before an image is recorded, management of the recording elements can be ensured than before. In particular, as the detection of a defective recording element is carried out immediately before a correction value is generated, a defective recording element becomes known at the time of generating the correction value, and the correction value can be generated in a state where the defective recording element is put in a non-ejecting state. Further, a defective recording element (in particular, an unstable defective recording element that may enter a state where ink cannot be ejected continuously) can be detected more reliably. Through this, generation of a non-uniform streak resulting from a defective recording element can be suppressed with a higher possibility than before. As a result, an image of higher quality than before can be formed. Furthermore, as the output from the detected defective recording element is stopped, even in a case where the defective recording element enters a state where an output (recording) is possible, the output from this defective recording element is not carried out. Through this, non-uniformity in an image is prevented from being overcorrected, and thus generation of an overcorrection non-uniform streak can be prevented.

### BRIEF DESCRIPTION OF THE DRAWINGS

FIG. 1 is a block diagram showing an electrical configuration of an inkjet printing system of a first embodiment;

FIG. 2 is a block diagram showing an electrical configuration of a PC;

FIGS. 3A and 3B are illustrative diagrams for describing an example of generation processing of a non-ejection correction LUT;

FIG. 4 is a schematic diagram of a malfunctioning nozzle sensing test chart;

FIG. 5 is an illustrative diagram for describing signal conversion processing by a nozzle ejection correction processing unit;

FIG. 6 is a flowchart for describing an action of the inkjet printing system of the first embodiment;

FIG. 7 is a flowchart for describing non-ejection correction processing;

FIG. 8 is a block diagram showing an electrical configuration of an inkjet printing system of a second embodiment;

FIG. 9 is a schematic diagram of a density non-uniformity correction test chart;

FIG. 10 is a graph showing an example of an ejection characteristics curve of a given nozzle;

FIG. 11 is an illustrative diagram showing an example of processing to obtain a density non-uniformity correction LUT for each nozzle;

FIG. 12 is a flowchart for describing an action of the inkjet printing system of the second embodiment;

FIG. 13 is a block diagram showing an electrical configuration of an inkjet printing system of a third embodiment;

FIG. 14 is a flowchart for describing an action of the inkjet printing system of the third embodiment;

FIG. 15 is a block diagram showing an electrical configuration of an inkjet printing system of a fourth embodiment;

FIG. 16 is an illustrative diagram for describing reset processing;

FIG. 17 is a flowchart for describing an action of the inkjet printing system of the fourth embodiment;

FIG. 18 is a schematic diagram of a malfunctioning nozzle information table in an inkjet printing system of a fifth embodiment;

FIG. 19 is a flowchart for describing an action of the inkjet printing system of the fifth embodiment;

FIG. 20 is a block diagram showing an electrical configuration of an inkjet printing system of a sixth embodiment;

FIG. 21 is a flowchart for describing an action of the inkjet printing system of the sixth embodiment;

FIG. 22 is a block diagram showing an electrical configuration of an inkjet printing system of a seventh embodiment;

FIG. 23 is a flowchart for describing an action of the inkjet printing system of the seventh embodiment;

FIG. 24 is an illustrative diagram for describing output stop processing when carrying out non-uniform streak correction in an inkjet printing system of another embodiment of the seventh embodiment;

FIG. 25 is an illustrative diagram for describing output stop processing when carrying out non-uniform streak correction and density non-uniformity correction in an inkjet printing system of another embodiment of the seventh embodiment;

FIG. 26 is an overall configuration diagram of an inkjet recording apparatus;

FIG. 27A is a perspective plan view showing a structural example of an inkjet head, whereas FIG. 27B is an enlarged view of a part thereof;

FIGS. 28A and 28B are perspective plan views that show another structural example of the head;

FIG. 29 is a sectional view along the A-A line in FIGS. 27A and 27B;

FIGS. 30A and 30B are illustrative diagrams for describing a non-uniform streak;

FIGS. 31A and 31B are illustrative diagrams for describing non-uniform streak correction; and

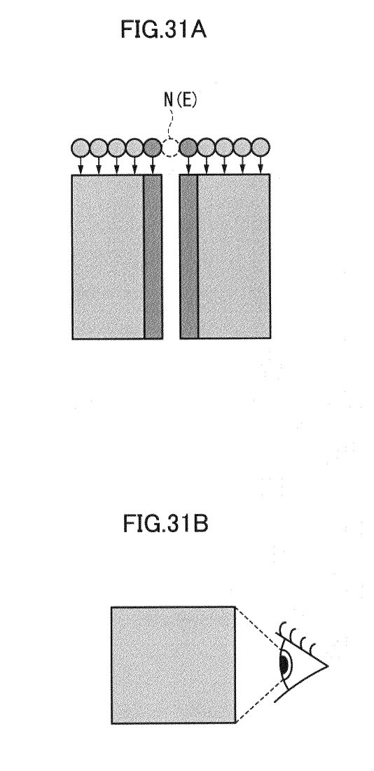

FIGS. 32A and 32B are illustrative diagram for describing an overcorrection non-uniform streak.

### DETAILED DESCRIPTION OF THE PREFERRED EMBODIMENTS

### Overall Configuration of Inkjet Printing System of First Embodiment

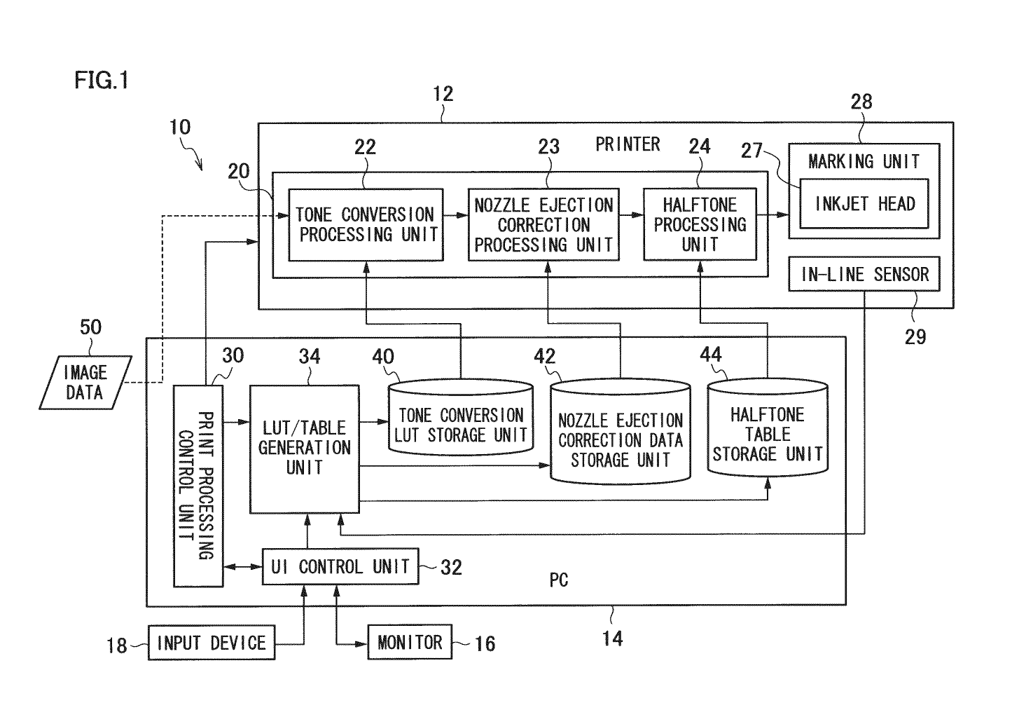

FIG. 1 is a block diagram showing a configuration example of an inkjet printing system (hereinafter, simply referred to as a printing system, an image recording apparatus) 10 according to a first embodiment of the present invention. The printing system 10 is a system that records an image through a single-pass method using an inkjet head that corresponds to a recording head of the present invention. In other words, by carrying out an operation to move a recording medium relative to the inkjet head only once (with a single sub-scan), an image of a predetermined recording resolution (for example, 1200 dpi) can be formed in an image forming region on the recording medium. In the printing system 10, four colors of inks, cyan (C), magenta (M), yellow (Y), and black (K), are used, and a case where inkjet heads for the respective colors are provided as devices for ejecting the ink of the respective colors will be described. However, the combination of the ink colors and the number of colors are not limited to the present embodiment.

The printing system 10 is configured of a printer 12, a computer body (hereinafter, referred to as a “PC”) 14, a monitor 16, and an input device 18.

The PC 14 is connected to the printer 12. The PC 14 functions as a control device to control an operation of the printer 12 and also functions as a data management device to manage various pieces of data.

The monitor 16 and the input device 18, which serve as a user interface (UI), are connected to the PC 14. The input device 18 can employ a device of various types such as a keyboard, a mouse, a touch panel, and a trackball, or can use a suitable combination of these. An operator operates the printer 12 using the monitor 16 and the input device 18. When a print instruction is directed from the PC 14, image data 50 such as page data are sent to the printer 12 and are processed in an image processing circuit (an image process board) 20.

### Configuration of Printer of First Embodiment

The printer 12 includes the image processing circuit 20 that includes various processing units (22, 23, 24) to carry out signal processing of converting the print image data 50 inputted through the PC 14 to a marking signal, a marking unit (an image recording device) 28 that drives inkjet heads 27 for the respective colors in accordance with the marking signal to carry out image recording, and an in-line sensor 29 that reads various test charts recorded by the marking unit 28.

The image processing circuit 20 includes a tone conversion processing unit 22, a nozzle ejection correction processing unit (a stopping device, an output correction device) 23, and a halftone processing unit 24. The image processing circuit 20, while carrying out various processing to generate a marking signal from the image data 50, carries out tone conversion processing, nozzle ejection correction processing, and halftone processing to generate the marking signal.

The tone conversion processing unit 22 is configured to carry out processing for determining the characteristics of the density tones, such as what density of color to use in image formation, when forming an image with the marking unit 28. The tone conversion processing unit 22 converts the image data 50 in such a manner that the coloring characteristics specified by the printer 12 (e.g., for four colors of cyan (C), magenta (M), yellow (Y) and black (K)) are achieved. For example, the tone conversion processing unit 22 converts a CMYK signal to a C′M′Y′K′ signal, or converts the C signal, the M signal, the Y signal and the K signal respectively to a C′ signal, an M′ signal, a Y′ signal and a K′ signal, in accordance with the tone conversion LUT.

In the signal conversion by the tone conversion processing unit 22, a conversion relationship is determined with reference to the tone conversion look-up table (LUT) (not shown) stored in a tone conversion LUT storage unit 40 in the PC 14. A plurality of LUTs that are optimized for the types of the recording media (paper to be used) are stored in the tone conversion LUT storage unit 40, and an appropriate LUT is referenced in accordance with a recording medium. Such a tone conversion LUT is prepared for each color of ink. In the present example, the tone conversion LUTs are provided for the respective colors of CMYK.

When a print execution instruction is inputted, the tone conversion LUT matching the corresponding print conditions is selected automatically and is set in the tone conversion processing unit 22 of the printer 12. Furthermore, by inputting instructions for selecting, modifying and correcting an LUT, and so on, through the input device 18, it is possible to set up a desired LUT.

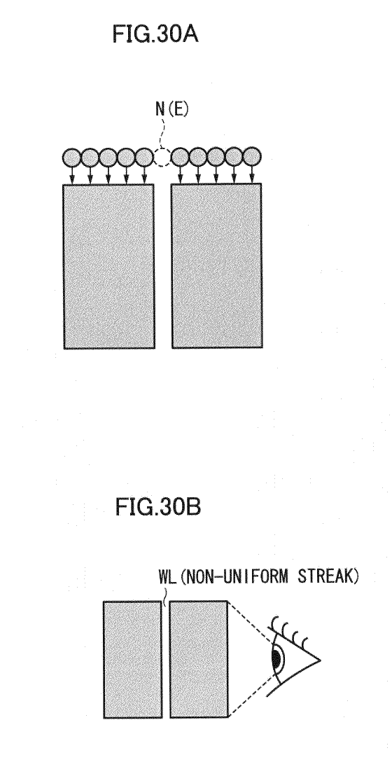

The nozzle ejection correction processing unit 23 is a processing unit to correct output density (an ink ejection amount) of each nozzle in the inkjet head 27 in order to correct non-uniformity in an image to be recorded on a recording medium. The “non-uniformity in an image” referred to here is a non-uniform streak (see FIGS. 30A and 30B) that results from a non-ejecting nozzle that cannot eject ink in a normal amount even with shading correction processing to increase an ejection amount of ink or that cannot eject ink at all. Further, a non-uniform streak does not result only from a non-ejecting nozzle but may also occur due to an ejection malfunctioning nozzle in which ejection malfunctions such as ink flying being skewed have occurred. In order to correct a non-uniform streak resulting from a malfunctioning nozzle (a defective recording element) such as a non-ejecting nozzle or an ejection malfunctioning nozzle described above, signal conversion is carried out by the nozzle ejection correction processing unit 23.

In other words, the nozzle ejection correction processing unit 23 converts an image signal in order to correct an ink ejection amount of, in particular, an adjacent nozzle that is adjacent to a malfunctioning nozzle among the plurality of nozzles in the inkjet head 27. Here, an adjacent nozzle is not limited to a nozzle that is adjacent to a malfunctioning nozzle and includes a nozzle that records a pixel adjacent to a pixel corresponding to a malfunctioning nozzle, in other words, a nozzle that is not necessarily adjacent to a malfunctioning nozzle. It should be noted that when an ink ejection amount of an adjacent nozzle is corrected, an ink ejection amount of a nozzle in the vicinity of the adjacent nozzle may be corrected at the same time as necessary.

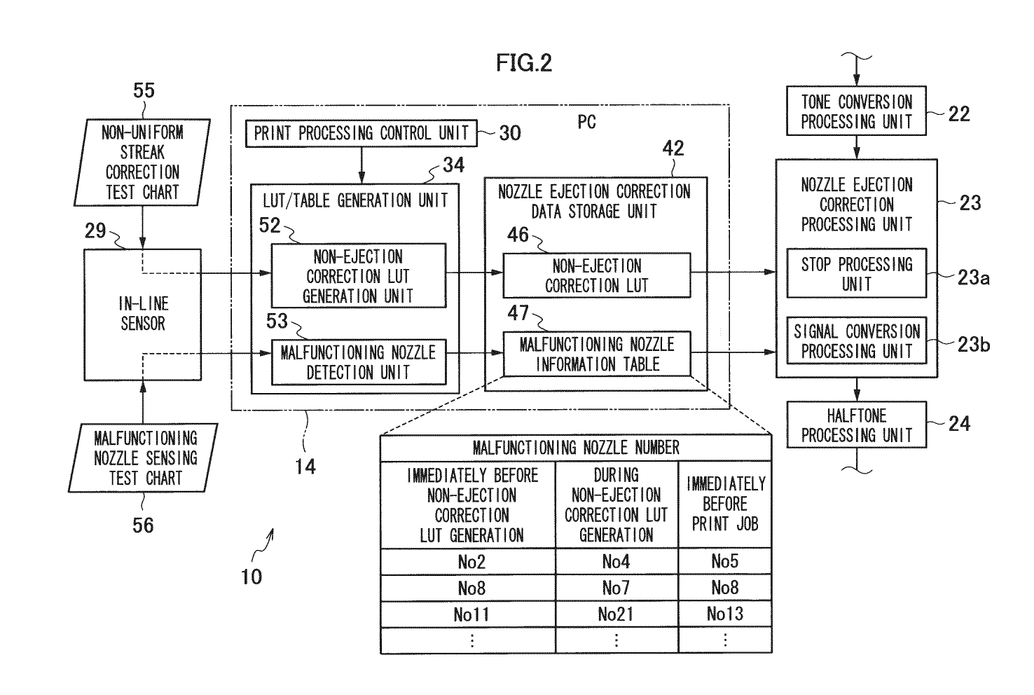

In the conversion of the image signal by the nozzle ejection correction processing unit 23, for example, a CMYK signal is converted to a C″M″Y″K″ signal, or a C′ signal, an M′ signal, a Y′ signal, and a K′ signal are converted to a C″ signal, an M″ signal, a Y″ signal, and a K″ signal respectively. In this conversion processing, a conversion relationship is determined with reference to the non-ejection correction LUT (a first correction value, see FIG. 2) stored in a nozzle ejection correction data storage unit 42 in the PC 14.

Further, the nozzle ejection correction processing unit 23 carries out output stop processing to cause the ejection (output) of ink from a malfunctioning nozzle to stop. To “cause the ejection of ink from a malfunctioning nozzle to stop” referred to here includes stopping the ejection of ink from a malfunctioning nozzle that was in a state where ink cannot be ejected normally but has entered a state where ink can be ejected normally. The nozzle ejection correction processing unit 23 carries out the output stop processing based on malfunctioning nozzle information that is registered in a malfunctioning nozzle information table (the memory device, see FIG. 2) 47 in the nozzle ejection correction data storage unit 42.

The halftone processing unit 24 converts the image signal having multiple tones (for example, 256 tones based on 8 bits per color), for each pixel, into a binary signal which indicates ink ejection or no ink ejection, or into a multiple-value signal indicating what type of droplet to eject, if a plurality of ink dot diameters (droplet sizes) can be selected. In general, processing is carried out to convert the multiple-tone image data having M values (where M is an integer not smaller than 3) into data having N values (where N is an integer smaller than M and not smaller than 2). The halftone processing can employ a dithering method, error diffusion method, density pattern method, or the like.

For example, in a case where the inkjet head 27 can distinctively eject droplets in three sizes of a large droplet, a medium droplet, and a small droplet, the halftone processing unit 24 converts the multiple tone (for example, 256 tones) data that have been subjected to the correction processing by the nozzle ejection correction processing unit 23 into a four-valued signal of “ejecting large droplet ink,” “ejecting medium droplet ink,” “ejecting small droplet ink,” and “not ejecting.” In the signal conversion by the halftone processing unit 24, a conversion relationship is determined with reference to a halftone table (not shown) that is stored in a halftone table storage unit 44 in the PC 14.

The halftone table specifies a ratio in which dots of the respective sizes (large/medium/small) are used per unit surface area, a dot ratio of the respective dot sizes being specified in accordance with the magnitude of the input signal. The halftone table storage unit 44 stores the halftone tables of a plurality of types, and one of the tables is selected when printing.

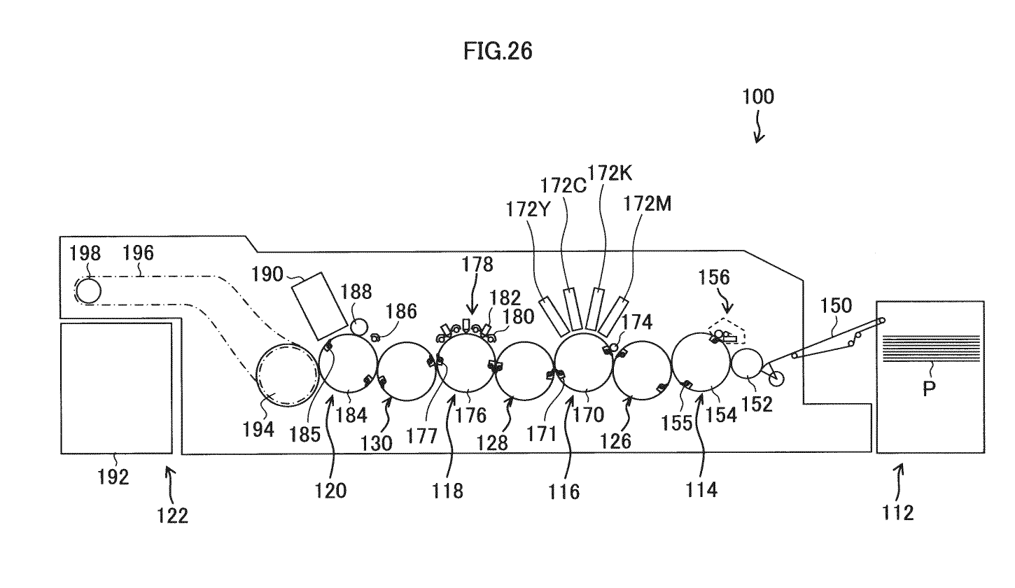

The marking unit 28 includes the inkjet heads 27 for the respective colors described above and a relative movement mechanism (each drum in FIG. 26) that moves the inkjet heads 27 and the recording medium relative to each other. A plurality of ink ejection nozzles are arranged along a length corresponding to the maximum width of an image forming region of a recording medium, on an ink ejection surface (nozzle surface) of each of the inkjet heads 27. A high recording resolution can be achieved by a configuration in which a large number of nozzles are arranged two-dimensionally on the ink ejection surface.

In a case of the inkjet head 27 having the two-dimensional nozzle arrangement, a projected nozzle row in which the nozzles are projected (by orthogonal projection) to an alignment in a direction (corresponding to a “main scanning direction”) which is perpendicular to a medium conveyance direction (corresponding to a “sub-scanning direction”) can be regarded as equivalent to a single nozzle row in which the nozzles are arranged at substantially even intervals at a nozzle density which achieves the recording resolution in the main scanning direction (a medium width direction). The phrase “substantially even intervals” means substantially even intervals between the droplet deposition points which can be recorded by the printing system. For example, the concept of “even intervals” also includes cases where there is a slight variation in the intervals, to take account of manufacturing errors or movement of the droplets on the medium due to landing interference. Taking account of the projected nozzle row (also referred to as an “effective nozzle row”), it is possible to associate the nozzle positions (nozzle numbers) in alignment sequence of the projected nozzles which are aligned following the main scanning direction. In the description given below, reference to “nozzle positions (nozzle numbers)” means the positions (numbers) of nozzles in the effective nozzle row.

The multiple-value signal (in the present embodiment, a four-value marking signal) generated by the halftone processing unit 24 is sent to the inkjet head 27 of the marking unit 28 and is used to control driving of ejection energy generating elements (for example, piezoelectric elements or heating elements) of the corresponding nozzles. More specifically, the ink ejection from the respective nozzles is controlled in accordance with this four-value signal. A large dot is recorded on the recording medium with the large ink droplet, a medium dot is recorded on the recording medium with the medium ink droplet, and a small dot is recorded on the recording medium with the small ink droplet. Thus, multiple tones are reproduced by surface area tones based on the arrangement of the ink dots formed on the recording medium.

The in-line sensor 29 configures a part of the correction value generation device of the present invention. A CCD line sensor or the like, for example, is employed as the in-line sensor 29, and the in-line sensor 29 reads various test charts formed on a recording medium by the inkjet head 27. Based on a read result (characteristic information) of a test chart by the in-line sensor 29, recording characteristics (for example, recording density, a depositing position error, and so on) of each nozzle or a malfunctioning nozzle can be detected.

### Configuration of PC of First Embodiment

The PC 14, as being roughly divided, includes a print processing control unit 30, a user interface (UI) control unit 32, an LUT/table generation unit 34, the tone conversion LUT storage unit 40, the nozzle ejection correction data storage unit (the memory device) 42, and the halftone table storage unit 44. Each of these units is configured by hardware or software of the PC 14 or a combination thereof.

The print processing control unit 30 controls the operation of the printer 12. The print processing control unit 30 controls various processing in the LUT/table generation unit 34 and so on and also carries out a display control of the monitor 16 or a control corresponding to an input instruction from the input device 18 in coordination with the UI control unit 32.

Further, the print processing control unit 30 carries out a creating instruction of a test chart and a reading instruction of a test chart to the printer 12. In response to these instructions, the printer 12 creates a test chart, reads a test chart with the in-line sensor 29, and outputs a read result thereof to the PC 14.

The LUT/table generation unit 34 generates, in response to a control signal from the print processing control unit 30 and an instruction signal (an operation signal) given from the UI control unit 32, image processing parameters (correction values) such as a tone conversion LUT, a non-ejection correction LUT 46, and a halftone table, and a malfunctioning nozzle information table 47.

As shown in FIG. 2, the LUT/table generation unit 34 includes a non-ejection correction LUT generation unit (a correction value generation device) 52 that generates a non-ejection correction LUT 46 and a malfunctioning nozzle detection unit (a first defective recording element detection device, a second defective recording element detection device, a third effective recording element detection device) 53 that detects a malfunctioning nozzle.

### <Non-ejection Correction LUT Generation Processing>

The non-ejection correction LUT generation unit 52 generates a non-ejection correction LUT 46 based on a read result (characteristic information) of a non-uniform streak correction test chart (a first test chart) 55 read by the in-line sensor 29. It should be noted that a timing to generate the non-ejection correction LUT 46 is arbitrary. For example, it is possible to adopt a mode where the non-ejection correction LUT 46 is generated when a generation start operation of the non-ejection correction LUT 46 is carried out in the input device 81, a mode where the non-ejection correction LUT 46 is generated each time a set period elapses, a mode where the non-ejection correction LUT 46 is generated each time a predetermined number of sheets are printed, a mode where the non-ejection correction LUT 46 is generated each with the type or the size of the recording medium is switched, and so on. Thus, the non-ejection correction LUT 46 is updated at an appropriate timing.

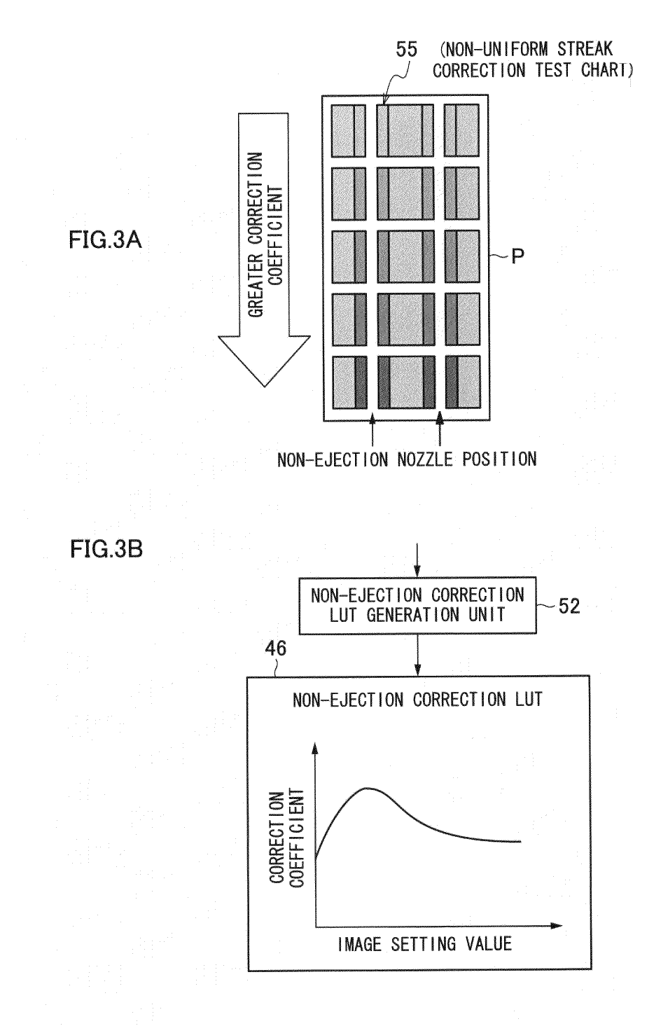

As shown in FIG. 3A, when the non-uniform streak correction test chart 55 is to be generated, a specified nozzle (at least one, preferably a plurality of nozzles appropriately spaced apart from one another) of the inkjet head 27 is caused not to eject ink (i.e., a specified nozzle is caused not to draw). To be more specific, the value (an image setting value that indicates the tone of the density) of the pixel at the drawing position of the specified nozzle is set to 0, or a non-ejection command is given to a head driver (a driving circuit) (not shown) of the inkjet head 27. Through this, the specified nozzle is put in a pseudo-non-ejecting state. The nozzle that is put in this pseudo-non-ejecting state is called a “pseudo-non-ejecting nozzle.”

At the same time, the image setting values of drawing positions of nozzles adjacent to the pseudo-non-ejecting nozzle to the front and rear are set to a value obtained by multiplying a base image setting value that corresponds to a solid image of predetermined density (a tone value) by a correction coefficient. For a base image setting value that corresponds to specified density, the correction coefficient is varied gradually (in stepwise) to draw a plurality of patches.

It should be noted that although an example where the correction coefficient is varied in five levels to draw five patches that correspond to the five correction coefficients is shown in FIG. 3A, the number of steps in which the correction coefficient is varied is not particularly limited. Further, although only a chart (a patch group) pertaining to a single base image setting value that corresponds to the specified density is shown here, similar patch groups are formed for a plurality of base image setting values of different densities (tone value).

For example, a range from 0 to 255 tones is equally divided into 32 levels, and for the base image setting value of each tone (density), the correction coefficient is varied stepwise in 20 levels to form 20 patch groups. That is, for a single pseudo-non-ejecting nozzle, 32×20 patches are formed. In terms of improving the measurement accuracy (improving the reliability in measurement), it is preferable that the pseudo-non-ejecting nozzles are provided in plurality, and similar patch groups are formed for the plurality of pseudo-non-ejecting nozzles. It should be noted that, without limiting to a mode where all the patch groups are recorded on a single piece of a recording medium P, these band-shaped patterns may be recorded across a plurality of pieces of the recording medium.

As shown in FIG. 3B, the non-ejection correction LUT generation unit 52 selects, among a plurality of patches that are drawn while changing the correction coefficient in the non-uniform streak correction test chart 55, a patch where a correction coefficient that most excels in visibility is used (fine output image quality where a streak is less noticeable is obtained), based on a read result of the non-uniform streak correction test chart 55 by the in-line sensor 29. Thus, the best correction coefficient is determined for each base image setting value, and the non-ejection correction LUT 46 is obtained. It should be noted that the non-ejection correction LUT 46 shown in FIG. 3B is an example of a non-ejection correction LUT.

The horizontal axis of the non-ejection correction LUT 46 represents the image setting value that indicates the density (the tone that serves as a base) of a solid instruction when a test chart is created, and the vertical axis represents a value determined as the correction coefficient that yields the best correction effect. Although a smoothly continuing graph is shown in FIG. 3B, in a case where, for example, a test chart is created while changing the base tone in 32 levels within a range of values from 0 to 255, discrete data that corresponds to each value is obtained. By using a publicly known interpolation method, intermediary data is estimated from the stated discrete data. Thereafter, the non-ejection correction LUT generation unit 52 stores the created non-ejection correction LUT 46 in the nozzle ejection correction data storage unit 42.

### <Malfunctioning Nozzle Information Registration Processing>

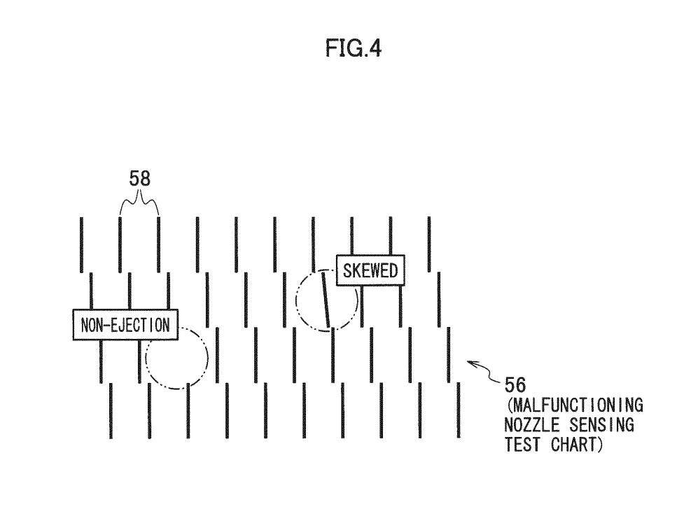

As shown in FIGS. 2 and 4, the malfunctioning nozzle detection unit 53 detects a malfunctioning nozzle among the nozzles of the inkjet head 27 based on a read result of a malfunctioning nozzle sensing test chart (a third test chart) 56 read by the in-line sensor 29 and generates malfunctioning nozzle information (defective recording element information) indicative of the detection result.

Generation of the malfunctioning nozzle information (detection of a malfunctioning nozzle) is carried out based on an instruction from the print processing control unit 30. To be more specific, the malfunctioning nozzle information is generated, respectively, immediately before the non-ejection correction LUT 46 described above is generated, while the non-ejection correction LUT 46 is generated, and in a period after the non-ejection correction LUT 46 is generated and before an image based on the inputted image data 50 is recorded (in the present embodiment, immediately before a print JOB (print processing)). In other words, the malfunctioning nozzle detection unit 53 functions as the first defective recording element detection device of the present invention immediately before the non-ejection correction LUT 46 is generated, functions as the second defective recording element detection device of the present invention while the non-ejection correction LUT 46 is generated, and also functions as the third defective recording element detection device of the present invention immediately before the print JOB.

The malfunctioning nozzle sensing test chart 56 is generated based on an instruction from the print processing control unit 30 immediately before the non-ejection correction LUT 46 is generated, while the non-ejection correction LUT 46 is generated (within a period spanning from the recording of the non-uniform streak correction test chart 55 until the storage of the non-ejection correction LUT 46), and immediately before the print JOB. When the malfunctioning nozzle sensing test chart 56 (see FIG. 4) is to be generated, a line pattern 58 is recorded on the recording medium P with each nozzle of the inkjet head 27. The malfunctioning nozzle sensing test chart 56 is a line pattern of a so-call “1 ON n OFF” type.

For example, in a single line head, a nozzle number is assigned, sequentially from an end thereof in the main scanning direction, to a nozzle alignment configuring the nozzle row (the effective nozzle row obtained through orthogonal projection) that is substantially aligned along the width direction (the main scanning direction) of the recording medium P. Then, the nozzles are grouped in nozzle groups that each simultaneously eject by a residue number “B” (B=0, 1, . . . , A−1) obtained by dividing a nozzle number by an integer “A” that is equal to or greater than 2, and a droplet ejection timing is varied for each group with each of the nozzle numbers AN+0, AN+1, . . . , AN+B (here, N is an integer that is equal to or greater than 0) to form a line group by continuous droplet ejection from each of the respective nozzles. Through this, a line pattern of 1 ON n OFF type is obtained.

By using the malfunctioning nozzle sensing test chart 56 as described above, the line patterns 58 of the adjacent nozzles that are adjacent to each other do not overlap with each other, and the line pattern 58 (for each individual nozzle) that is independent and can be distinguished from other nozzles can be formed for all of the nozzles.

In the malfunctioning nozzle sensing test chart 56, as indicated by “non-ejection” within a rectangular frame in FIG. 4, a line pattern 58 that corresponds to a non-ejecting nozzle is missed. Accordingly, the position (the nozzle number) of the non-ejecting nozzle can be identified. Further, in the malfunctioning nozzle sensing test chart 56, as indicated by “skewed” within a rectangular frame in FIG. 4, a line pattern 58 that corresponds to an ejection malfunctioning nozzle in which eject malfunctions such as ink flying to be skewed have occurred is skewed. Accordingly, the position of the ejection malfunctioning nozzle can be identified.

It should be noted that the malfunctioning nozzle sensing test chart 56 may include, aside from the line patterns of “1 ON n OFF” type described above, other patterns such as another line block (for example, a block for confirming a position error among line blocks) and a traverse line (a partition line) to divide between line blocks. Further, the malfunctioning nozzle sensing test chart 56 is formed for each of the inkjet heads 27 for the respective ink colors.

The malfunctioning nozzle detection unit 53 analyzes the malfunctioning nozzle sensing test chart 56, as described above, to detect the position of a malfunctioning nozzle such as a non-ejecting nozzle and an ejection malfunctioning nozzle and generates malfunctioning nozzle information that includes the nozzle number indicating the position of such malfunctioning nozzle. The malfunctioning nozzle information is registered (recorded) in the malfunctioning nozzle information table 47 of the nozzle ejection correction data storage unit 42.

In the malfunctioning nozzle information table 47 (see FIG. 2), the malfunctioning nozzle information that is detected/generated immediately before the non-ejection correction LUT 46 is generated (“immediately before non-ejection correction LUT generation”), the malfunctioning nozzle information that is detected/generated while the non-ejection correction LUT 46 is generated (“during non-ejection correction LUT generation”), and the malfunctioning nozzle information that is detected/generated immediately before the print JOB (“immediately before print JOB”) are registered separately from one another. In FIG. 2, “No. ˜” indicates the nozzle number. It should be noted that being “registered separately from one another” referred to here means that the each piece of the malfunctioning nozzle information generated immediately before the non-ejection correction LUT is generated, while the non-ejection correction LUT is generated, and immediately before the print JOB are registered in a state that allows each piece to be differentiated, and a table of a registration format that is different from that of the malfunctioning nozzle information table 47 may be used instead.

### <Operation of Nozzle Ejection Correction Processing Unit>

The nozzle ejection correction processing unit 23 is provided with a stop processing unit (a stopping device) 23a, and a signal conversion processing unit (an output correction device) 23b.

The stop processing unit 23a refers to the malfunctioning nozzle information that is stored in the malfunctioning nozzle information table 47 to carry out output stop processing on all of the malfunctioning nozzles that correspond to the malfunctioning nozzle information. Through this, the malfunctioning nozzle that is detected at least any one of immediately before the non-ejection correction LUT is generated, while the non-ejection correction LUT is generated, and immediately before the print JOB is put in a non-ejecting state. It should be noted that “immediately before the non-ejection correction LUT 46 is generated” is before the non-uniform streak correction test chart 55 is recorded.

The signal conversion processing unit 23b operates when the image data is outputted (for example, when the image data 50 is inputted to the PC 14). The signal conversion processing unit 23b carries out signal conversion processing of an image signal that has been subjected to the signal conversion processing by the tone conversion processing unit 22, based on the non-ejection correction LUT 46 in the nozzle ejection correction data storage unit 42.

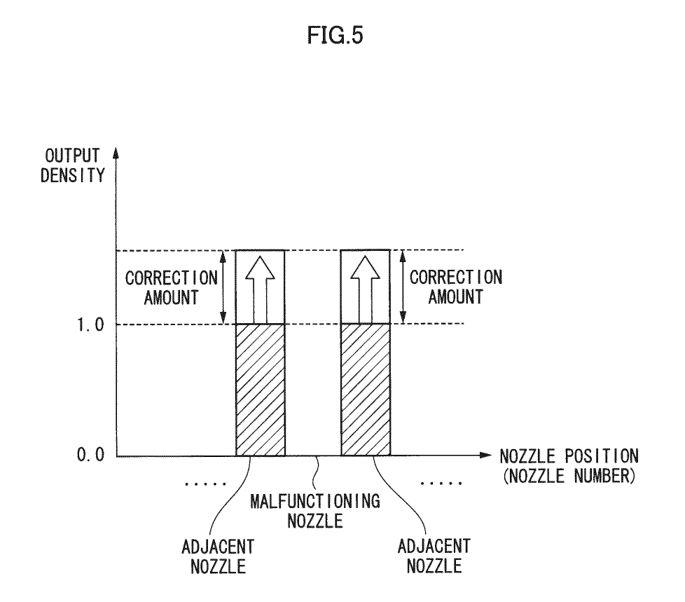

As shown in FIG. 5, through the signal conversion processing by the signal conversion processing unit 23b, the output density (the ink ejection amount) of adjacent nozzles that are adjacent to the malfunctioning nozzle that has been subjected to the output stop processing is increased by a correction amount determined through the non-ejection correction LUT 46 or the like. In FIG. 5, the output density of each of the adjacent nozzles is increased from 1.0 (before correction: displayed in hatched lines) to, for example, 1.5 (after correction). It should be noted that FIG. 5 merely shows an example of correction of the output density of the adjacent nozzles, and the correction amount may be determined as appropriate. Further, the correction amounts of the adjacent nozzles located at respective two sides of the malfunctioning nozzle may be set to differ from each other. In addition, as described above, correction of the output density of nozzles in the vicinity of the adjacent nozzles may also be carried out at the same time. The image signal that has been subjected to the signal conversion processing by the signal conversion processing unit 23b is sent to the halftone processing unit 24.

### Action of Inkjet Printing System of First Embodiment

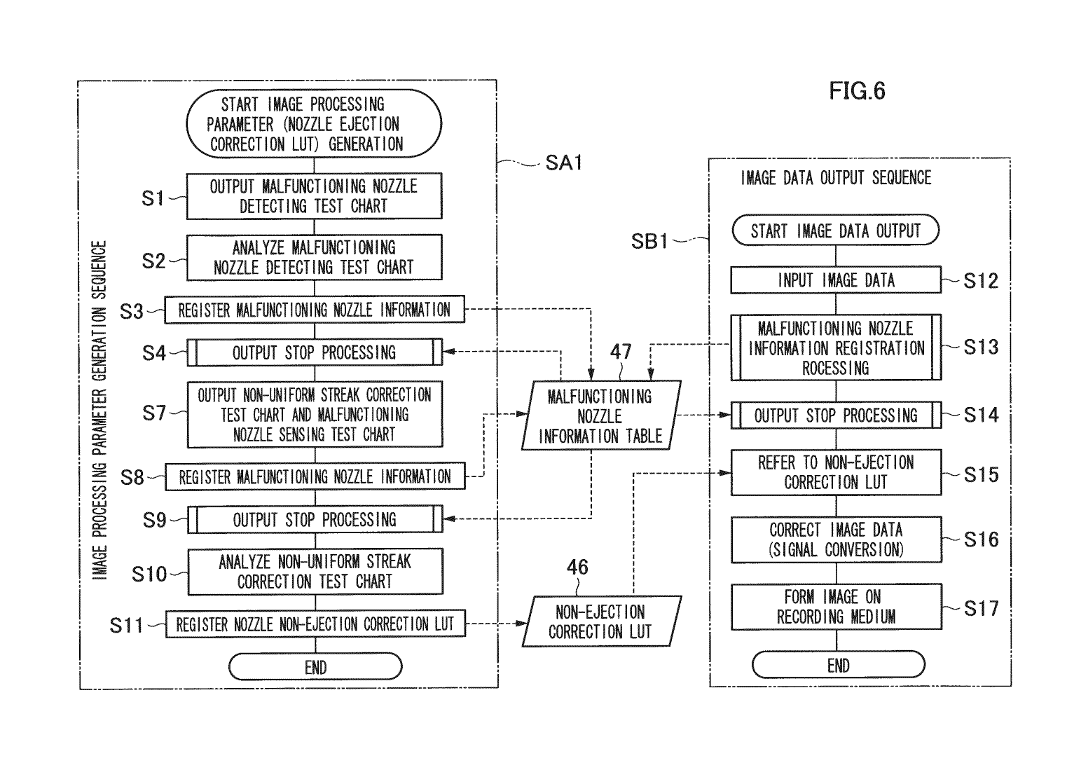

An action of the printing system 10 having the above-described configuration will be described using a flowchart shown in FIG. 6. It should be noted that processing to obtain the non-ejection correction LUT 46 as an image processing parameter will be referred to as an “image processing parameter generation sequence SA1 (hereinafter, simply abbreviated to the sequence SA1).” Further, processing to output the image data 50 (image recording) will be referred to as an “image data output sequence SB1 (hereinafter, simply abbreviated to the sequence SB1).”

### <Image Processing Parameter Generation Sequence SA1>

First, the sequence SA1 will be described. When an operation to start generating the non-ejection correction LUT 46 is carried out in the input device 18, or after a predetermined number of sheets are printed, the print processing control unit 30 sends a test chart creation instruction to the printer 12. In response to this test chart creation instruction, the malfunctioning nozzle sensing test chart 56 is recorded (outputted) on the recording medium P in the marking unit 28 (step S1).

After the malfunctioning nozzle sensing test chart 56 is recorded, the print processing control unit 30 sends a test chart reading instruction to the printer 12. In response to this instruction, the malfunctioning nozzle sensing test chart 56 is transported toward the in-line sensor 29, and the malfunctioning nozzle sensing test chart 56 is read by the in-line sensor 29. A read result of the malfunctioning nozzle sensing test chart 56 by the in-line sensor 29 (characteristic information) is inputted to the LUT/table generation unit 34.

Subsequently, the print processing control unit 30 sends a malfunctioning nozzle detection instruction to the malfunctioning nozzle detection unit 53. In response to this instruction, the malfunctioning nozzle detection unit 53 analyzes the read result of the malfunctioning nozzle sensing test chart 56 to detect a malfunctioning nozzle among the nozzles of the inkjet head 27 (step S2). Then, the malfunctioning nozzle detection unit 53 registers the malfunctioning nozzle information that indicates the detection result of the malfunctioning nozzle under the column “immediately before non-ejection correction LUT generation” of the malfunctioning nozzle information table 47 (step S3).

After the malfunctioning nozzle information is registered, the print processing control unit 30 sends an output stop instruction to the stop processing unit 23a. In response to this instruction, the stop processing unit 23a refers to the malfunctioning nozzle information table 47 to start the output stop processing of the malfunctioning nozzle (step S4).

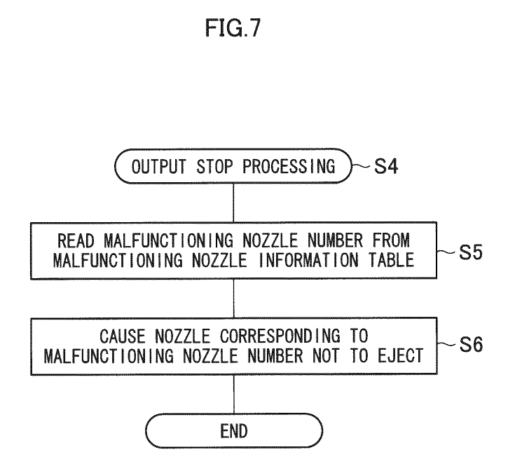

As shown in FIG. 7, the stop processing unit 23a first reads out all of the malfunctioning nozzle numbers (the malfunctioning nozzle information) from the malfunctioning nozzle information table 47 (step S5). Then, the stop processing unit 23a causes all the malfunctioning nozzles that correspond to the malfunctioning nozzle numbers read out from the malfunctioning nozzle information table 47 not to eject (output stopped) (step S6).

Referring back to FIG. 6, after the output stop processing of the malfunctioning nozzles, the print processing control unit 30 sends a test chart creation instruction to the printer 12. In response to this test chart creation instruction, the non-uniform streak correction test chart 55 and the malfunctioning nozzle sensing test chart 56 are recorded (outputted) on the recording medium P in the marking unit 28 (step S7). Each of the test charts 55 and 56 that are recorded on the recording medium P is read by the in-line sensor 29, and the read results (characteristic information) are sequentially inputted to the LUT/table generation unit 34.

Subsequently, the print processing control unit 30 sends a malfunctioning nozzle detection instruction to the malfunctioning nozzle detection unit 53. In response to this instruction, the malfunctioning nozzle detection unit 53 analyzes the read result of the malfunctioning nozzle sensing test chart 56 to register the malfunctioning nozzle information that pertains to the malfunctioning nozzle into the column “during non-ejection correction LUT generation” of the malfunctioning nozzle information table 47 (step S8). After this malfunctioning nozzle information is registered, the print processing control unit 30 sends an output stop instruction to the stop processing unit 23a. In response to this instruction, the stop processing unit 23a carries out the output stop processing, which has been described above in step S4, (step S9). Through this, all of the malfunctioning nozzles that correspond to the malfunctioning nozzle numbers read out from the malfunctioning nozzle information table 47 are caused not to eject.

Further, the print processing control unit 30 sends a non-ejection correction LUT generation instruction to the non-ejection correction LUT generation unit 52. In response to this instruction, the non-ejection correction LUT generation unit 52 analyzes the read result of the non-uniform streak correction test chart 55 to generate the non-ejection correction LUT 46, as described above with reference to FIG. 3 (step S10). Then, the non-ejection correction LUT generation unit 52 registers the generated non-ejection correction LUT 46 into the nozzle ejection correction data storage unit 42 (step S11). Thus, the sequence SA1 is completed.

Hereinafter, a flow from the output (or after the output) of the malfunctioning nozzle sensing test chart 56 to the registration processing of the malfunctioning nozzle information will be referred to as “malfunctioning nozzle information registration processing.” Further, a flow from the output of the non-uniform streak correction test chart 55 (the malfunctioning nozzle sensing test chart 56) to the processing to register the non-ejection correction LUT 46 through the registration of the malfunctioning nozzle information and the output stop processing will be referred to as “non-ejection correction LUT/malfunctioning nozzle information registration processing.”

### <Image Data Output Sequence SB1>

Subsequently, the sequence SB1 will be described. After the image data 50 is inputted to the PC 14 (step S12), when an operation to start printing is carried out in the input device 18, the print processing control unit 30 sends the image data 50 to the printer 12 and also causes the malfunctioning nozzle information registration processing to be carried out (step S13). Through this, malfunctioning nozzle information that pertains to a newly detected malfunctioning nozzle is registered under the column “immediately before print JOB” of the malfunctioning nozzle information table 47.

After the malfunctioning nozzle information is registered, the print processing control unit 30 sends an output stop instruction to the stop processing unit 23a. In response to this instruction, the stop processing unit 23a carries out the output stop processing (step S14). Through this, all of the malfunctioning nozzles that correspond to the malfunctioning nozzle numbers read out from the malfunctioning nozzle information table 47 are caused not to eject.

After the output stop processing of the malfunctioning nozzles, the print processing control unit 30 sends an image processing instruction to the image processing circuit 20. In response to this instruction, the tone conversion processing unit 22, the nozzle ejection correction processing unit 23, and the halftone processing unit 24 of the image processing circuit 20 operate. It should be noted that an LUT that corresponds to a printing condition is set in each of the processing units 22, 23b, and 24.

The tone conversion processing unit 22 converts the image data 50 (the image signal) inputted from the PC 14 in accordance with a conversion relationship determined through the tone conversion LUT.

The signal conversion processing unit 23b refers to the non-ejection correction LUT 46 that has been set previously (step S15) to carry out, in accordance with a conversion relationship determined through this non-ejection correction LUT 46, the signal conversion processing of the image signal that has been subjected to the signal conversion processing in the tone conversion processing unit 22 (step S16). Through this, as described above with reference to FIG. 5, the output density of the adjacent nozzles is corrected. Then, the halftone processing unit 24 converts the multiple tone image signal that has been subjected to the signal conversion processing by the signal conversion processing unit 23b into a multiple-value (for example, four-valued) signal. This multiple-value signal is then sent to the marking unit 28.

In the marking unit 28, the driving of each nozzle in the inkjet head 27 is controlled based on the multiple-value signal inputted from the halftone processing unit 24, and thus ink is ejected from each nozzle. By recording dots on the recording medium with each nozzle while moving the inkjet head 27 and the recording medium P relative to each other, an image is formed on the recording medium P (step S17).

### Effects of First Embodiment

In the present embodiment, since the detection of the malfunctioning nozzle is carried out, respectively, immediately before the non-ejection correction LUT (image processing parameter) is generated, while the non-ejection correction LUT is generated, and immediately before the print JOB, management of the nozzles can be ensured than before. In particular, by carrying out the detection of the malfunctioning nozzle immediately before the non-ejection correction LUT (image processing parameter) is generated, the malfunctioning nozzle among the nozzles in the inkjet head when the non-uniform streak correction test chart 55 is outputted becomes known. Through this, non-uniform streak correction can be carried out using the non-uniform streak correction test chart 55 that has been created in a state where the malfunctioning nozzle is put in a non-ejecting state. In this way, since the nozzle management is ensured than before (for example, Japanese Patent Application Laid-Open No. 2011-73285 and so on), generation of a non-uniform streak (a black streak, a white streak) can be suppressed more reliably.

Furthermore, in the present embodiment, since the detection of the malfunctioning nozzle is carried out, respectively, immediately before the non-ejection correction LUT (image processing parameter) is generated, while the non-ejection correction LUT is generated, and immediately before the print JOB, the malfunctioning nozzle can be detected more reliably as compared to a case where the detection of the malfunctioning nozzle is carried out only once prior to printing. In particular, in a case where an unstable malfunctioning nozzle that enters a state where ink cannot be ejected continuously has occurred, this malfunctioning nozzle can be detected at any one of immediately before non-ejection correction LUT is generated, while the non-ejection correction LUT is generated, and immediately before the print JOB. Through this, generation of a non-uniform streak (see FIGS. 30A and 30B) resulting from the malfunctioning nozzle can be suppressed with a higher possibility than before. As a result, an image of higher quality than before can be obtained.

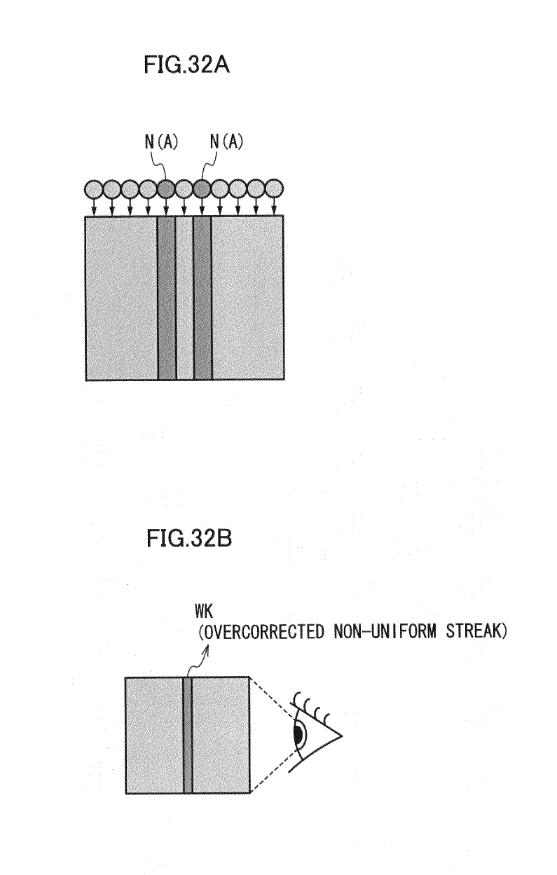

In addition, by carrying out the non-ejection correction processing on the malfunctioning nozzle that is detected at any one of immediately before the non-ejection correction LUT (image processing parameter) is generated, while the non-ejection correction LUT is generated, and immediately before the print JOB, even if the malfunctioning nozzle enters an ejectable state, ejection of ink from this malfunctioning nozzle is prevented. Through this, correction by the nozzle ejection correction processing unit 23 is prevented from leading to overcorrection, and thus generation of an overcorrection non-uniform streak (see FIGS. 32A and 32B) can be prevented.

### Configuration of Inkjet Printing System of Second Embodiment

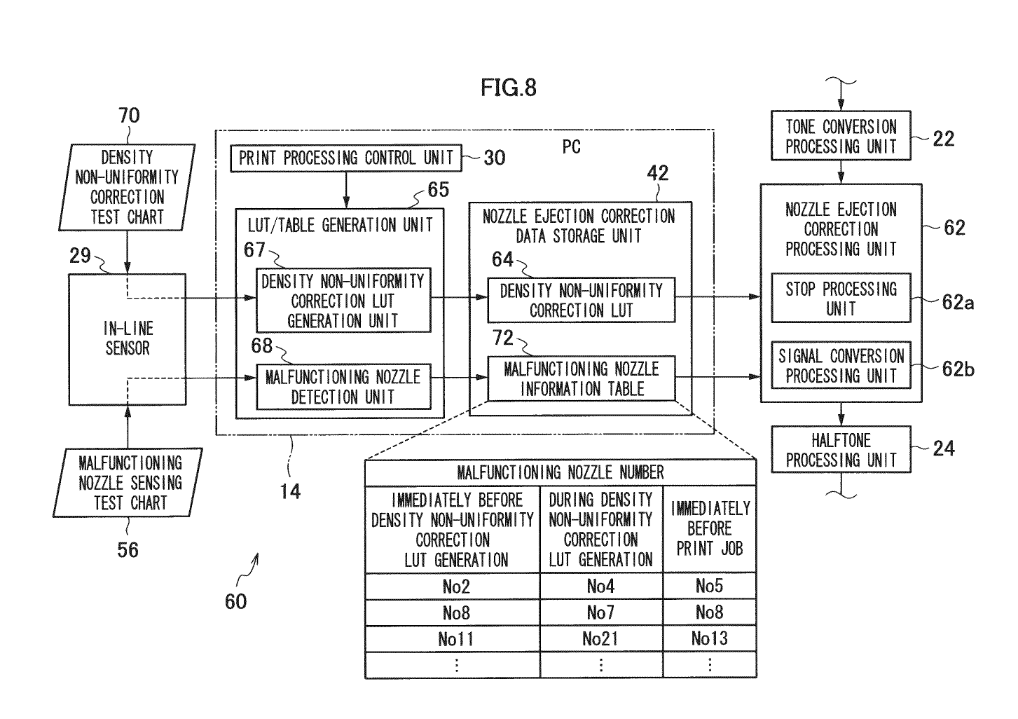

A printing system 60 of a second embodiment of the present invention will now be described using FIG. 8. In the printing system 10 of the first embodiment described above, correction of a non-uniform streak resulting from a malfunctioning nozzle is carried out by the nozzle ejection correction processing unit 23. However, in the printing system 60, correction of density non-uniformity (density unevenness) generated in a recorded image due to a variation in ejection characteristics (recording characteristics) of each nozzle of the inkjet head 27 is carried out.

The printing system 60 basically has the same configuration as the printing system 10 of the first embodiment described above except in that correction of density non-uniformity resulting from a variation in the ejection characteristics of each nozzle (hereinafter, simply referred to as density non-uniformity) is carried out. Accordingly, items that are the same in terms of the function and the configuration as those in the first embodiment will be given the same reference characters, and the description thereof will be omitted.

### Configuration of Printer of Second Embodiment

The printer 12 (see FIG. 1) of the second embodiment basically has the same configuration as the printer 12 of the first embodiment except in that a nozzle ejection correction processing unit 62 that differs from that of the first embodiment is provided.

The nozzle ejection correction processing unit 62 carries out, in addition to the output stop processing of the malfunctioning nozzle as described above, correction of the output density (ink ejection amount) of each nozzle. To be more specific, when ink is to be ejected from each nozzle of the inkjet head 27 through an input signal of a constant tone value, the output density of each nozzle is corrected such that the density defined by the tone conversion processing unit 22 becomes uniform density over the whole surface of the recording medium. In the inkjet head 27, the ejection characteristics vary among the nozzles, and an amount of an ejected droplet is not necessary uniform. In order to correct the output density non-uniformity that results from a variation in the ejection performance for each nozzle as described above on a nozzle-by-nozzle basis, signal conversion is carried out in the nozzle ejection correction processing unit 62.

In other words, the nozzle ejection correction processing unit 62 converts an image signal to correct an ejection amount of each nozzle, in such a manner that the ink ejection amount of each nozzle in the inkjet head 27 comes within a prescribed tolerance range, both within each head and between heads, thereby eliminating color non-uniformity in a plane of the image.

For example, the nozzle ejection correction processing unit 62 converts a CMYK signal to a C″M″Y″K″ signal, or converts a C′ signal, an M′ signal, a Y′ signal, and a K′ signal respectively to a C″ signal, an M″ signal, a Y″ signal, and a K″ signal. In this conversion processing, a conversion relationship is determined with reference to a density non-uniformity correction LUT 64 stored in the nozzle ejection correction data storage unit 42 in the PC 14.

### Configuration of PC of Second Embodiment

The PC 14 of the second embodiment basically has the same configuration as the PC 14 of the first embodiment except in that an LUT/table generation unit 65 that differs from that of the first embodiment is provided.

The LUT/table generation unit 65 includes a density non-uniformity correction LUT generation unit (correction value generation device) 67 that generates the density non-uniformity correction LUT 64 (a second correction value) serving as an image processing parameter and a malfunctioning nozzle detection unit (the first to third defective recording element detection devices) 68 that detects a malfunctioning nozzle.

### <Density Non-Uniformity Correction LUT Generation Processing>

The density non-uniformity correction LUT generation unit 67 generates the density non-uniformity correction LUT 64 based on a read result of a density non-uniformity correction test chart (a second test chart) 70 read by the in-line sensor 29. It should be noted that as for the timing to generate the density non-uniformity correction LUT 64, there are various modes similarly to the non-ejection correction LUT 46 of the first embodiment, and the density non-uniformity correction LUT 64 is updated at an appropriate timing.

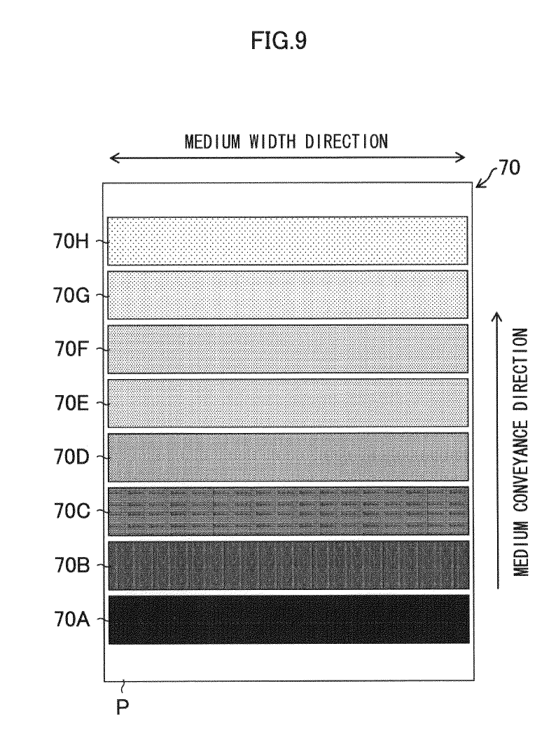

As shown in FIG. 9, the density non-uniformity correction test chart 70 includes a plurality of types of band-shaped patterns 70A to 70H (here, eight types) which have different tone values. Each of the band-shaped patterns 70A to 70H has a long rectangular shape in the medium width direction, which is perpendicular to the medium conveyance direction (the sub-scanning direction). The medium width direction is the substantial main scanning direction. Further, each of the band-shaped patterns 70A to 70H is formed to a substantially uniform density in a range corresponding to the length of the nozzle row. Here, “substantially uniform density” means constant in terms of the tone instruction value (set value) when recording the pattern. By measuring a density distribution of a pattern formed on the basis of the constant tone value instruction, it is possible to ascertain the variation of the ejection characteristics of the respective nozzles corresponding to this tone value.

In the present embodiment, the example is given in which the patterns 70A to 70H having the different densities are formed in sequence of decreasing ink density from an upstream side toward a downstream side in the medium conveyance direction (from the bottom to the top in FIG. 9), the arrangement sequence of the patterns and the number of the band-shaped patterns (the number of steps in which the density is changed) are not particularly limited. A set tone value which records each of the band-shaped patterns can be set as appropriate, and the number of the band-shaped patterns can also be designed as appropriate. The density non-uniformity correction test chart 70 as such is formed for respective colors by the inkjet heads 27 for the respective colors of CMYK. Further, the density non-uniformity correction test chart 70 is not limited to a mode where all of the patterns 70A to 70H are recorded on a single piece of the recording medium P, and it is also possible to record these band-shaped patterns over a plurality of pieces of the recording medium P.

The density non-uniformity correction LUT generation unit 67 analyzes image data that is a read result (characteristic information) of the density non-uniformity correction test chart 70 read by the in-line sensor 29. From the image data, an optical density (OD) value is determined at each position in the read image. As a result, output density data indicating output recording density (ink density) for each nozzle corresponding to each position in the read image is acquired. Then, a characteristics curve indicating the ejection characteristics (recording characteristics) of each nozzle is acquired on the basis of the stated output density data and the value of the input tone value.

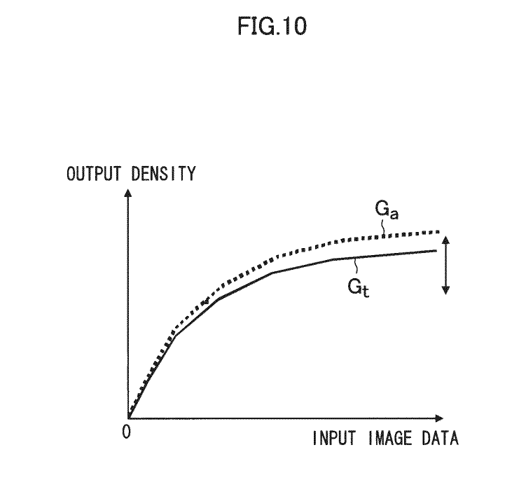

FIG. 10 is a graph showing an example of the ejection characteristics curve of a given nozzle. The horizontal axis represents the input image data (input tone value), and the vertical axis represents the output density. A curve Gt in FIG. 10 shows the characteristics curve of the nozzle acquired from the read result of the density non-uniformity correction test chart 70. A curve Ga indicated by a broken line in FIG. 10 represents the characteristics curve (proper characteristics curve) to be obtained when proper ink ejection is carried out in line with design expectations. As shown in FIG. 10, the actual characteristics curve Gt of a nozzle typically deviates to a certain extent from the proper characteristics curve due to a manufacturing variation or some other factors, and hence a variation in the output density value among the nozzles can be observed as indicated by a double-headed vertical arrow in FIG. 10. The characteristics curve Gt of each nozzle is compared to the proper characteristics curve Ga, and a table of correction values (the density non-uniformity correction LUT 64) for controlling ejection of the corresponding nozzle is generated in accordance with the comparison result.

In this way, the density non-uniformity correction LUTs 64 are obtained for all of the nozzles, and the density non-uniformity correction LUTs 64 for all of the nozzles are stored in the nozzle ejection correction data storage unit 42. It should be noted that, by comparing the nozzle characteristics curve Gt and the proper characteristics curve Ga, it is also possible to judge whether or not the nozzle is a non-ejecting nozzle and whether or not the nozzle is an ejection malfunctioning nozzle which is of a level that cannot be corrected. Furthermore, it is also possible to form a test pattern including a so-called 1 ON n OFF type of line pattern, and to ascertain a non-ejecting nozzle, ejection amount abnormality, depositing position errors, and the like from the read results.

### <Overview of Specific Calculation Method of Density Non-Uniformity Correction LUT>

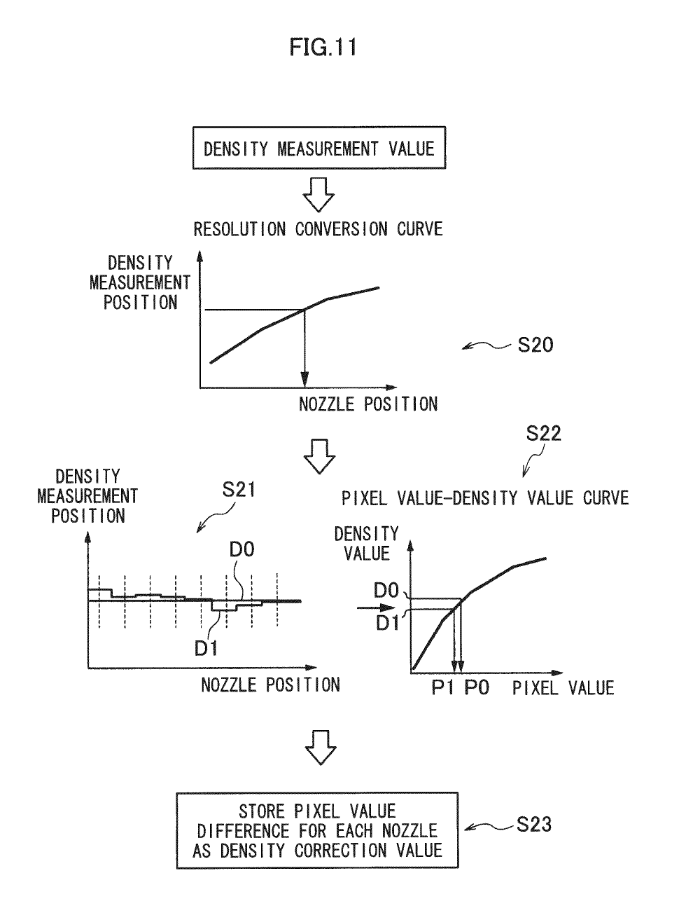

FIG. 11 is an illustrative diagram showing a specific example of processing to obtain the density non-uniformity correction LUT 64 for each nozzle. As indicated by S20 in FIG. 11, table data of a resolution conversion curve indicating a correspondence relationship between a pixel position (density measurement position) of the in-line sensor 29 and a nozzle position is previously stored in a memory. Accordingly, based on this resolution conversion curve, each of the density measurement positions (for example, a pixel position at a reading resolution of 400 dpi) in the reading data (scan image) of the density non-uniformity correction test chart 70 is converted to a corresponding nozzle position (for example, a nozzle position within a nozzle row which achieves a recording resolution of 1200 dpi) in the inkjet head 27.

The thus determined nozzle positions and the density measurement values (output density values) D1 in the test chart corresponding to the nozzle positions are associated as shown in S21 in FIG. 11, and the differences between the previously determined and stored target density values D0 and the density measurement values (output density values) D1 are calculated. The target density value D0 used here is a target value for the ink density ejected from the corresponding nozzle, and can be determined appropriately according to requirements. For example, it is also possible to calculate an average density of the ink ejected from a predetermined nozzle range and to store this average density as the target density value D0.

As shown in S22 in FIG. 11, the output pixel values (the “pixel values” in S22) P1 and P0 which correspond respectively to the density measurement value (output density value) D1 and the target density value D0 (the “density value” in S22) are determined in accordance with a pixel value/density value curve, which indicates a correspondence relationship between the pixel value and the density value that is determined previously by experimentation. The difference (P0-P1) between the output pixel values is stored as the density correction value for each nozzle position (S23).

Thereby, the correction value corresponding to the input signal value (pixel value) is determined for each nozzle, and the density non-uniformity correction LUT64 which specifies the relationships between the output signals and the input signals is obtained for each nozzle. The procedure for generating the density non-uniformity correction LUT64 described above is no more than an illustrative example, and it is also possible to create the density non-uniformity correction LUT64 by another procedure.

### <Malfunctioning Nozzle Information Registration Processing>

Referring back to FIG. 8, the malfunctioning nozzle detection unit 68 is basically the same as the malfunctioning nozzle detection unit 53 of the first embodiment and detects a malfunctioning nozzle based on a read result of the malfunctioning nozzle sensing test chart 56 to generate the malfunctioning nozzle information. However, the malfunctioning nozzle detection unit 68 generates the malfunctioning nozzle information immediately before the density non-uniformity correction LUT 64 is generated, while the density non-uniformity correction LUT 64 is generated (in a period spanning from the recording of the density non-uniformity correction test chart 70 until the storage of the density non-uniformity correction LUT 64), and in a period after the density non-uniformity correction LUT 64 is generated and immediately before the print JOB. The malfunctioning nozzle information is registered (recorded) in a malfunctioning nozzle information table 72 in the nozzle ejection correction data storage unit 42.

In the malfunctioning nozzle information table 72, the malfunctioning nozzle information that is detected/generated immediately before the density non-uniformity correction LUT 64 is generated (“immediately before density non-uniformity correction LUT generation”), the malfunctioning nozzle information that is detected/generated while the density non-uniformity correction LUT 64 is generated (“during density non-uniformity correction LUT generation”), and the malfunctioning nozzle information that is detected/generated immediately before the print JOB (“immediately before print JOB”) are registered as being differentiated from one another.

### Operation of Nozzle Ejection Correction Processing Unit of Second Embodiment

The nozzle ejection correction processing unit 62 is provided with a stop processing unit (the output stopping device) 62a, and a signal conversion processing unit (the output correction device) 62b. The stop processing unit 62a, basically as in the stop processing unit 23a of the first embodiment, carries out the output stop processing on all of the malfunctioning nozzles corresponding to the malfunctioning nozzle information registered in the malfunctioning nozzle information table 72. Through this, a malfunctioning nozzle that is detected at any one of immediately before the density non-uniformity correction LUT 64 is generated, while the density non-uniformity correction LUT 64 is generated, and immediately before the print JOB is caused not to eject.

The signal conversion processing unit 62b carries out signal conversion processing of the image signal that has been subjected to the signal conversion processing by the tone conversion processing unit 22, based on the density non-uniformity correction LUT 64 in the nozzle ejection correction data storage unit 42. Through this, the output density (ink ejection amount) of each nozzle is corrected. At this time as well, as in the first embodiment (see FIG. 5), the density non-uniformity correction LUT 64 may be determined as appropriate so that the output density (ink ejection amount) of, in particular, adjacent nozzles that are adjacent to the malfunctioning nozzle is increased. Then, the image signal that has been subjected to the signal conversion processing by the signal conversion processing unit 62b is sent to the halftone processing unit 24.

### <Action of Inkjet Printing System of Second Embodiment>

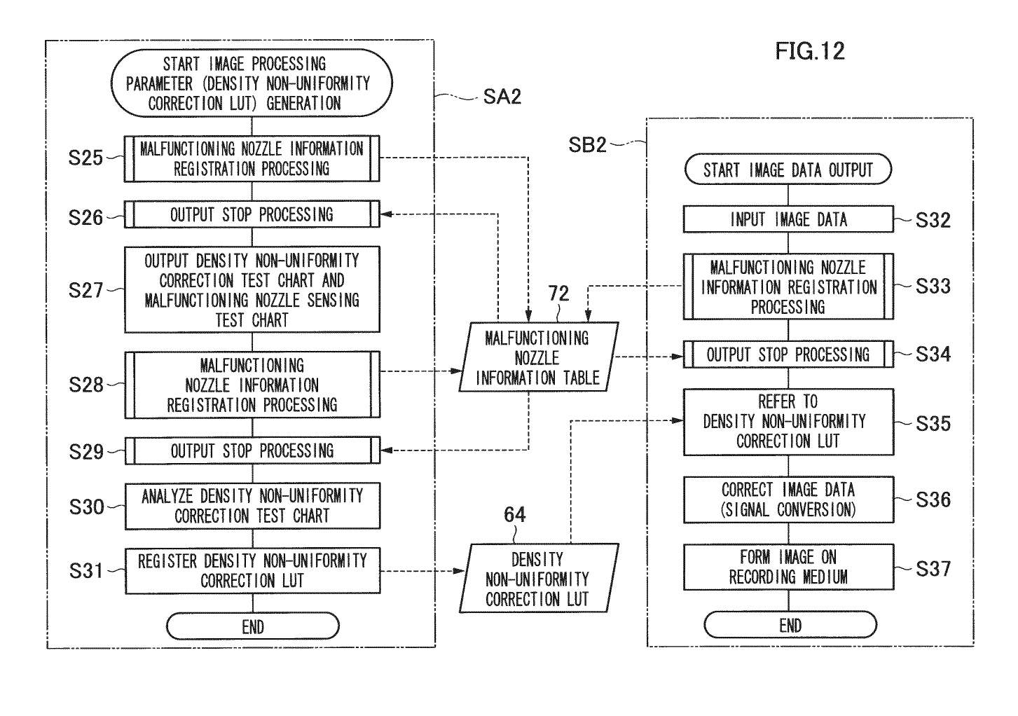

Using a flowchart shown in FIG. 12, an action of the printing system 60 having the above-described configuration, more specifically, an “image processing parameter generation sequence SA2 (hereinafter, simply abbreviated to the sequence SA2)” and an “image data output sequence SB2 (hereinafter, simply abbreviated to the sequence SB2)” will be described.

### <Image Processing Parameter Generation Sequence SA2>

The sequence SA2 is the same as the sequence SA1 of the first embodiment except in that the density non-uniformity correction LUT 64 is generated instead of generating the non-ejection correction LUT 46. When an operation to start generating the density non-uniformity correction LUT 64 is carried out in the input device 18, or after a predetermined number of sheets are printed, the print processing control unit 30 causes the malfunctioning nozzle information registration processing to be carried out (step S25). Through this, the malfunctioning nozzle information is registered under the column “immediately before density non-uniformity correction LUT generation” in the malfunctioning nozzle information table 72.

After the malfunctioning nozzle information is registered, the print processing control unit 30 sends an output stop instruction to the stop processing unit 62a. In response to this instruction, the stop processing unit 62a carries out the output stop processing (step S26). Through this, all of the malfunctioning nozzles corresponding to the malfunctioning nozzle numbers read out from the malfunctioning nozzle information table 72 are caused not to eject (output stopped).

After the output stop processing of the malfunctioning nozzles, the print processing control unit 30 sends a test chart creation instruction to the printer 12. In response to this test chart creation instruction, the density non-uniformity correction test chart 70 and the malfunctioning nozzle sensing test chart 56 are recorded (outputted) on the recording medium P in the marking unit 28 (step S27). Each of the test charts 70 and 56 that are recorded on the recording medium P is read by the in-line sensor 29, and the read results thereof (characteristic information) are sequentially inputted to the LUT/table generation unit 65.

Subsequently, the print processing control unit 30 causes the malfunctioning nozzle information registration processing to be carried out (the malfunctioning nozzle sensing test chart 56 has already been outputted, step S28). Through this, the malfunctioning nozzle information is registered under the column “during density non-uniformity correction LUT generation” in the malfunctioning nozzle information table 72. Then, after the malfunctioning nozzle information is registered, the print processing control unit 30 causes the output stop processing to be carried out (step S29). Through this, all of the malfunctioning nozzles corresponding to the malfunctioning nozzle numbers read out from the malfunctioning nozzle information table 72 are caused not to eject.

Further, the print processing control unit 30 sends a density non-uniformity correction LUT generation instruction to the density non-uniformity correction LUT generation unit 67. In response to this instruction, the density non-uniformity correction LUT generation unit 67 analyzes the read result of the density non-uniformity correction test chart 70 to generate the density non-uniformity correction LUT 64, as described above with reference to FIGS. 10 and 11 (step S30). Then, the density non-uniformity correction LUT generation unit 67 registers the generated density non-uniformity correction LUT 64 in the nozzle ejection correction data storage unit 42 (step S31). Thus, the sequence SA2 is completed.

Hereinafter, a flow from the output of the density non-uniformity correction test chart 70 (the malfunctioning nozzle sensing test chart 56) to the processing to register the density non-uniformity correction LUT 64 through the registration of the malfunctioning nozzle information and the output stop processing will be referred to as “density non-uniformity correction LUT/malfunctioning nozzle information registration processing.”

### <Image Data Output Sequence SB2>

The sequence SB2 is the same as the sequence SB1 of the first embodiment except in that the density non-uniformity (density unevenness) is corrected using the density non-uniformity correction LUT 64 instead of generating the non-ejection correction LUT 46.

After the image data 50 is inputted to the PC 14 (step S32), when an operation to start printing is carried out, the print processing control unit 30 sends the image data 50 to the printer 12 and also causes the malfunctioning nozzle information registration processing to be carried out (step S33). Through this, malfunctioning nozzle information that pertains to a newly detected malfunctioning nozzle is registered under the column “immediately before print JOB” of the malfunctioning nozzle information table 72.

After the malfunctioning nozzle information is registered, the print processing control unit 30 causes the stop processing unit 62a to carry out the output stop processing (step S34). Through this, all of the malfunctioning nozzles corresponding to the malfunctioning nozzle numbers read out from the malfunctioning nozzle information table 72 are caused not to eject.

After the output stop processing of the malfunctioning nozzles, the print processing control unit 30 sends an image processing instruction to the image processing circuit 20. In response to this instruction, the tone conversion processing unit 22 converts the image data 50 inputted from the PC 14 in accordance with a conversion relationship determined through the tone conversion LUT.

Subsequently, the signal conversion processing unit 62b refers to the density non-uniformity correction LUT 64 (step S35) to carry out the signal conversion processing on the image signal that has been subjected to the signal conversion processing by the tone conversion processing unit 22, in accordance with the conversion relationship determined through the density non-uniformity correction LUT 64 (step S36). Through this, the output density (ink ejection amount) of each nozzle is corrected so that the density defined in the tone conversion processing unit 22 becomes uniform over the whole surface of the recording medium. The multiple tone image signal that has been subjected to the signal conversion processing by the signal conversion processing unit 62b is converted to a multiple-value (for example, four-valued) signal by the halftone processing unit 24 and then sent to the marking unit 28.

The marking unit 28 forms an image on the relatively moved recording medium P based on the multiple-value signal inputted from the halftone processing unit 24 (step S37).

### Effects of Second Embodiment

With the printing system 60 of the second embodiment as well, since the detection of the malfunctioning nozzle is carried out immediately before the density non-uniformity correction LUT is generated, while the density non-uniformity correction LUT is generated, and immediately before the print JOB, management of the nozzles can be ensured than before, and the malfunctioning nozzle can be detected reliably. As a result, similar effects as those described in the first embodiment can be obtained.

### Configuration of Inkjet Printing System of Third Embodiment

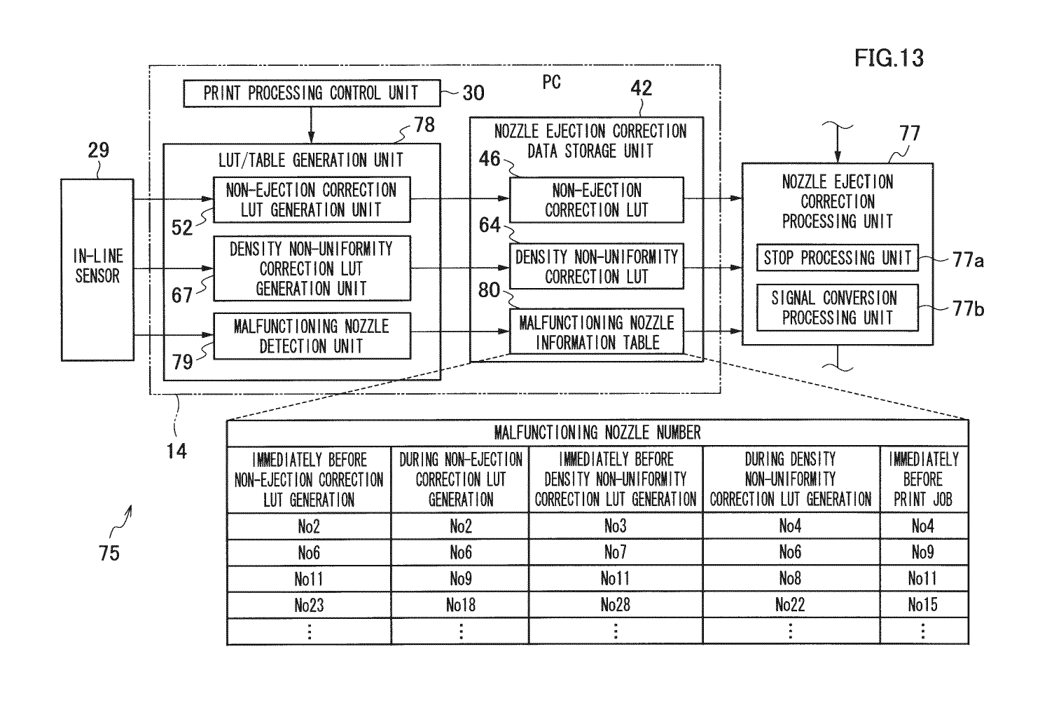

A printing system 75 of a third embodiment of the present invention will now be described using FIG. 13. Although a non-uniform streak is corrected in the printing system 10 of the first embodiment described above and density non-uniformity is corrected in the printing system 60 of the second embodiment described above, both non-uniform streak and density non-uniformity are corrected in the printing system 75.

It should be noted that the printing system 75 basically has the same configuration as the printings systems 10 and 60 of the first and second embodiments described above except in that both non-uniform streak and density non-uniformity are to be corrected. Therefore, items that are the same in terms of the function and the configuration as those in the first and second embodiments will be given the same reference characters, and the description thereof will be omitted.

### Configuration of Printer of Third Embodiment

The printer 12 (see FIG. 1) of the third embodiment basically has the same configuration as the printer 12 of the first embodiment except in that a nozzle ejection correction processing unit 77 that differs from that of the first and second embodiments is provided. The nozzle ejection correction processing unit 77 carries out the non-ejection correction processing and the signal conversion processing described above.

### Configuration of PC of Third Embodiment

The PC 14 of the third embodiment basically has the same configuration as the PC 14 of the first embodiment except in that an LUT/table generation unit 78 that differs from that of the first embodiment is provided and in that the non-ejection correction LUT 46, the density non-uniformity correction LUT 64, and a malfunctioning nozzle information table 80 are stored in the nozzle ejection correction data storage unit 42.

The LUT/table generation unit 78 includes the non-ejection correction LUT generation unit 52 and the density non-uniformity correction LUT generation unit 67, which are described above, and a malfunctioning nozzle detection unit (the first to third defective recording element detection devices) 79.

### <Malfunctioning Nozzle Information Registration Processing>

The malfunctioning nozzle detection unit 79 is basically the same as the malfunctioning nozzle detection unit 53 of the first embodiment and detects a malfunctioning nozzle based on a read result of the malfunctioning nozzle sensing test chart 56 to generate the malfunctioning nozzle information that indicates the detection result. However, the malfunctioning nozzle detection unit 79 generates the malfunctioning nozzle information immediately before and while the non-ejection correction LUT 46 is generated, immediately before and while the density non-uniformity correction LUT 64 is generated, and immediately before the print JOB. The malfunctioning nozzle information is registered (recorded) in the malfunctioning nozzle information table 80 in the nozzle ejection correction data storage unit 42.

In the malfunctioning nozzle information table 80, the malfunctioning nozzle information pieces that are detected/generated immediately before and while the non-ejection correction LUT 46 is generated (“immediately before non-ejection correction LUT generation,” “during non-ejection correction LUT generation”), the malfunctioning nozzle information pieces that are detected/generated immediately before and while the density non-uniformity correction LUT 64 is generated (“immediately before density non-uniformity correction LUT generation,” “during density non-uniformity correction LUT generation”), and the malfunctioning nozzle information piece that is detected/generated immediately before the print JOB (“immediately before print JOB”) are registered being differentiated from one another.

### Operation of Nozzle Ejection Correction Processing Unit of Third Embodiment

The nozzle ejection correction processing unit 77 is provided with a stop processing unit (the output stopping device) 77a, and a signal conversion processing unit 77b. The stop processing unit 77a carries out the non-ejection correction processing on all of the malfunctioning nozzles corresponding to the malfunctioning nozzle information registered in the malfunctioning nozzle information table 80. Through this, a malfunctioning nozzle that is detected at any one of immediately before and while the non-ejection correction LUT is generated, immediately before and while the density non-uniformity correction LUT is generated, and immediately before the print JOB is caused not to eject.

The signal conversion processing unit 77b carries out signal conversion processing of the image signal that has been subjected to the signal conversion processing by the tone conversion processing unit 22, based on the non-ejection correction LUT 46 and the density non-uniformity correction LUT 64 in the nozzle ejection correction data storage unit 42. In other words, the non-ejection correction LUT 46 and the density non-uniformity correction LUT 64 are used in combination as the image processing parameter. Through this, the output density (ink ejection amount) of each nozzle is corrected, and the output density (ink ejection amount) of, in particular, adjacent nozzles that are adjacent to the malfunctioning nozzle is increased. Then, the image signal that has been subjected to the signal conversion processing by the signal conversion processing unit 77b is sent to the halftone processing unit 24.

### Action of Inkjet Printing System of Third Embodiment

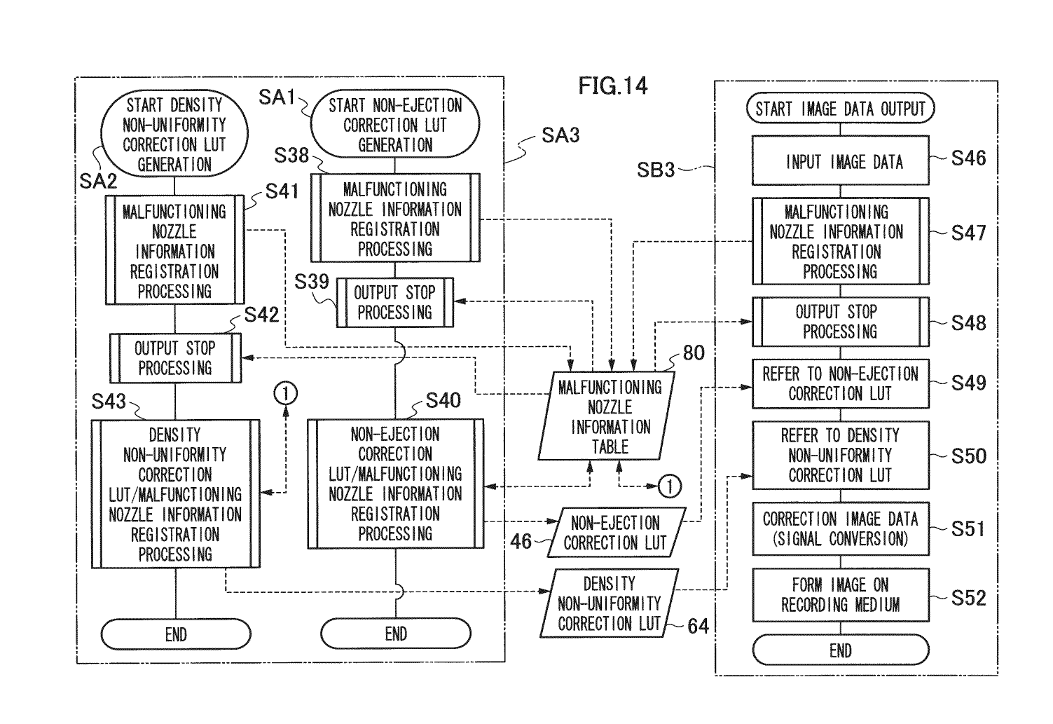

Using a flowchart shown in FIG. 14, an action of the printing system 75 having the above-described configuration, more specifically, an “image processing parameter generation sequence SA3 (hereinafter, simply abbreviated to the sequence SA3)” and an “image data output sequence SB3 (hereinafter, simply abbreviated to the sequence SB3)” will be described.

### <Image Processing Parameter Generation Sequence SA3>

At an appropriate timing such as when an operation to start generating each of the LUTs 46 and 64 is carried out in the input device 18 or after a predetermined number of sheets are printed, the print processing control unit 30 carries out each processing of the sequence SA1 shown in FIG. 6 and each processing of the sequence SA2 shown in FIG. 12.

In the sequence SA1, the malfunctioning nozzle information registration processing (step S38), the non-ejection correction processing (step S39), and the non-ejection correction LUT/malfunctioning nozzle information registration processing (step S40) are carried out. Through this, the registration processing of the malfunctioning nozzle information under the column “immediately before non-ejection correction LUT generation,” the output stop processing of the malfunctioning nozzle, the registration processing of the malfunctioning nozzle information under the column “during non-ejection correction LUT generation,” the output stop processing of the malfunctioning nozzle, and the registration processing of the non-ejection correction LUT 46 are carried out.

In the sequence SA2, the malfunctioning nozzle information registration processing (step S41), the non-ejection correction processing (step S42), and the density non-uniformity correction LUT/malfunctioning nozzle information registration processing (step S43) are carried out. Through this, the registration processing of the malfunctioning nozzle information under the column “immediately before density non-uniformity correction LUT generation,” the output stop processing of the malfunctioning nozzle, the registration processing of the malfunctioning nozzle information under the column “during density non-uniformity correction LUT generation,” the output stop processing of the malfunctioning nozzle, and the registration processing of the density non-uniformity correction LUT 64 are carried out.

### <Image Data Output Sequence SB3>

In the sequence SB3, after the image data is inputted (step S46), the malfunctioning nozzle information registration processing (step S47) and the output stop processing (step S48) are carried out similarly to the sequences SB1 and SB2. Through this, a malfunctioning nozzle that is detected at any one of immediately before and while the non-ejection correction LUT is generated, immediately before and while the density non-uniformity correction LUT is generated, and immediately before the print JOB is caused not to eject.

Subsequently, the print processing control unit 30 sends an image processing instruction to the image processing circuit 20. Through this, the tone conversion processing unit 22 carries out the tone conversion processing on the image data in accordance with a conversion relationship determined through the tone conversion LUT.

The signal conversion processing unit 77b refers to each of the non-ejection correction LUT 46 and the density non-uniformity correction LUT 64 (S49, S50) to carry out the signal conversion processing on the image signal that has been subjected to the tone conversion processing, in accordance with a conversion relationship determined through each of the LUTs 46 and 64 (step S51). Through this, the output density (ink ejection amount) of each nozzle is corrected so that the density defined in the tone conversion processing unit 22 becomes uniform over the whole surface of the recording medium, and further the output density of the adjacent nozzles is corrected so that a non-uniform streak is corrected.

Thereafter, as in the first and second embodiments described above, the signal conversion processing by the halftone processing unit 24 and the image formation by the marking unit 28 are carried out (step S52).

### Effects of Third Embodiment

With the printing system 75 of the third embodiment, since the detection of the malfunctioning nozzle is carried out, respectively, immediately before and while the non-ejection correction LUT is generated, immediately before and while the density non-uniformity correction LUT is generated, and immediately before the print JOB, similar effects to those of the first and second embodiments described above can be obtained.

### Configuration of Inkjet Printing System of Fourth Embodiment

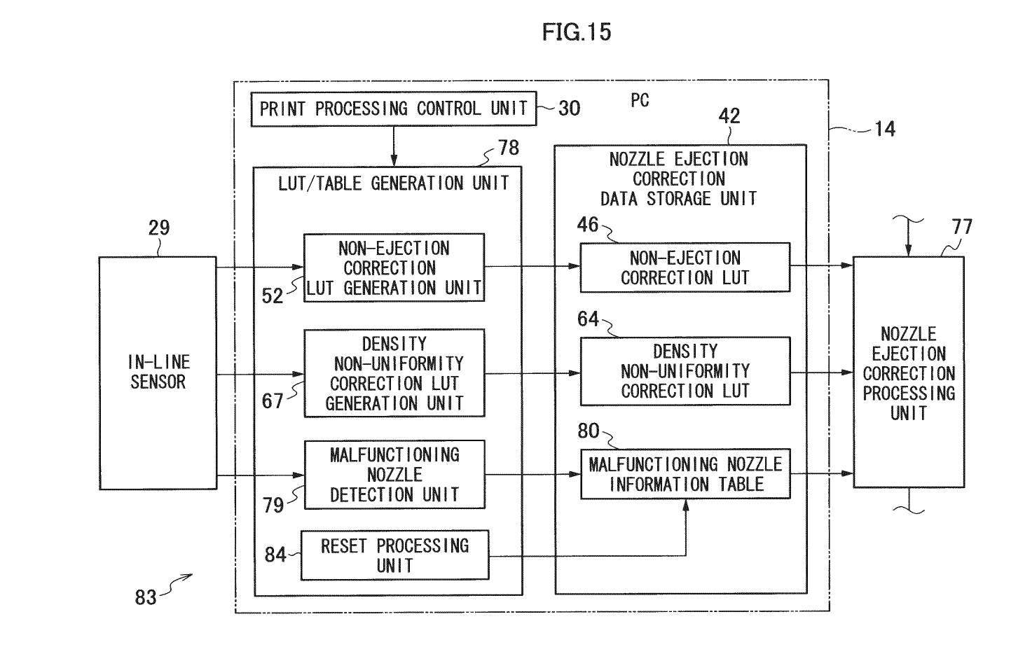

A printing system 83 of a fourth embodiment of the present invention will now be described using FIG. 15. Although a case where generation of the non-ejection correction LUT 46 and the density non-uniformity correction LUT 64 is carried out once in the printing system 75 of the third embodiment has been described above, in the printing system 83, each of the LUTs 46 and 64 is generated a plurality of times.

The printing system 83 basically has the same configuration as the printing system 75 of the third embodiment except in that the LUT/table generation unit 78 of the PC 14 is provided with a reset processing unit (a first information deletion device) 84, and thus items that are the same in terms of the function and the configuration as those in the third embodiment described above will be given the same reference characters, and the description thereof will be omitted.

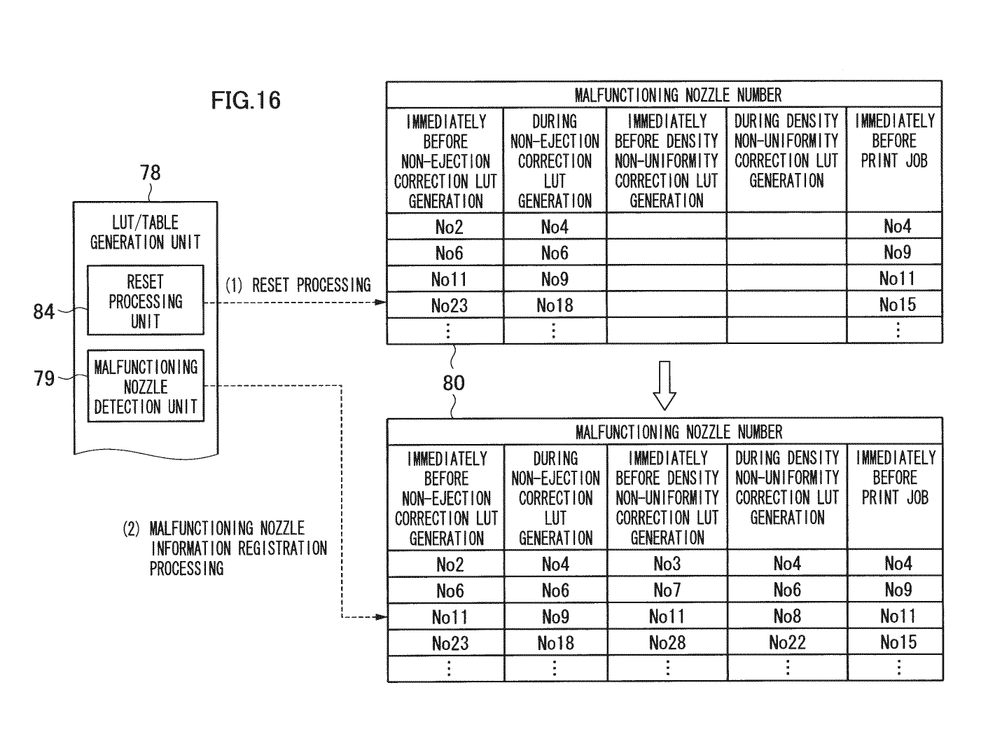

As shown in FIG. 16, the reset processing unit 84 operates when at least one of the LUTs 46 and 64 is to be newly generated (hereinafter, referred to as regeneration as appropriate). Examples of such regeneration timings include, as stated above, when an operation to start generating the LUTs 46 and 64 is carried out in the input device 18, when a predetermined time elapses, when a predetermined number of sheets are printed, and when the type or the size of the recording medium is switched.

As indicated by the parenthetical number (1) in FIG. 16, when, for example, the density non-uniformity correction LUT 64 is to be regenerated, the reset processing unit 84 carries out reset processing to delete the entire malfunctioning nozzle information that is registered under the columns “immediately before density non-uniformity correction LUT generation” and “during density non-uniformity correction LUT generation” of the malfunctioning nozzle information table 80. Further, although not shown in the drawings, when the non-ejection correction LUT 46 is to be regenerated, the reset processing is carried out on the malfunctioning nozzle information that is registered under the columns “immediately before non-ejection correction LUT generation” and “during non-ejection correction LUT generation.” In addition, when both LUTs 46 and 64 are to be regenerated, the reset processing is carried out on the malfunctioning nozzle information that is registered under the columns “immediately before density non-uniformity correction LUT generation” and “during density non-uniformity correction LUT generation” and under the columns “immediately before non-ejection correction LUT generation” and “during non-ejection correction LUT generation.”

As indicated by the parenthetical number (2) in FIG. 16, after the reset processing by the reset processing unit 84, the malfunctioning nozzle detection unit 79 newly registers the malfunctioning nozzle information of the malfunctioning nozzle that is detected when, for example, the density non-uniformity correction LUT 64 is regenerated under each of the columns “immediately before density non-uniformity correction LUT generation” and “during density non-uniformity correction LUT generation” of the malfunctioning nozzle information table 80. It should be noted that, similarly when the non-ejection correction LUT 46 is to be regenerated, the malfunctioning nozzle information of a newly detected malfunctioning nozzle is registered into the malfunctioning nozzle information table 80. <Action of Inkjet Printing System of Fourth Embodiment>

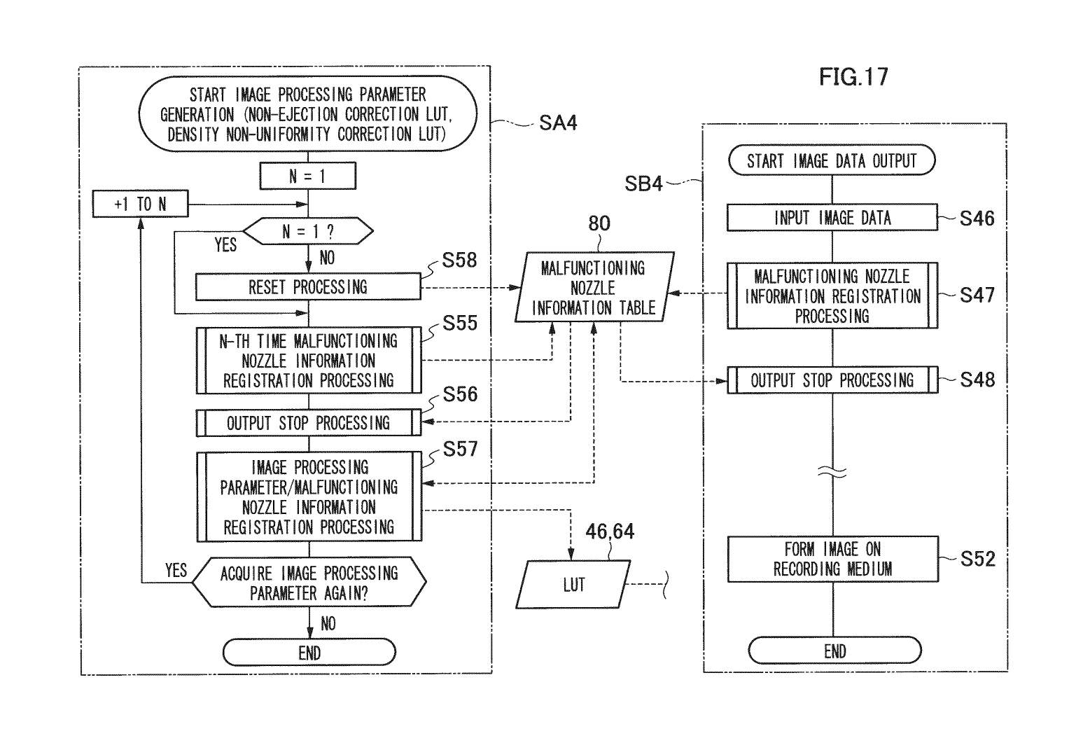

An action of the printing system 75 having the above-described configuration will be described using a flowchart shown in FIG. 17. It should be noted that an image data output sequence SB4 is the same as the sequence SB3 of the third embodiment, and thus only an “image processing parameter generation sequence SA4 (hereinafter, simply abbreviated to the sequence SA4)” will be described. It should be noted that “N” in FIG. 17 indicates the number of times the image processing parameter (the non-ejection correction LUT 46, the density non-uniformity correction LUT 64) is generated.

### <Image Processing Parameter Generation Sequence SA4>

In the sequence SA4, when the image processing parameter is generated for the first time (N=1), similarly to the sequence SA3 of the third embodiment described above with reference to FIG. 14, the malfunctioning nozzle information registration processing (step S55), the output stop processing (step S56), and the image processing parameter/malfunctioning nozzle information registration processing (step S57) are carried out. Then, when it is determined that the image processing parameter is to be regenerated (N=2), the reset processing unit 84 operates.

The reset processing unit 84 determines the type of the image processing parameter to be regenerated and carries out the reset processing to delete the registered malfunctioning nozzle information that corresponds to the determination result from the malfunctioning nozzle information table 80 (step S58).

Subsequently, as steps S55 to S57 described above are repeatedly carried out, the malfunctioning nozzle information on a newly detected malfunctioning nozzle is registered into the malfunctioning nozzle information table 80, and the image processing parameter (the non-ejection correction LUT 46, the density non-uniformity correction LUT 64) is generated and stored. Then, when it is determined that the image processing parameter is again to be regenerated, the above-described processing is repeatedly carried out.

### Effects of Fourth Embodiment

In this way, in the fourth embodiment, when the image processing parameter is to be regenerated, the newly obtained malfunctioning nozzle information is registered into the malfunctioning nozzle information table 80 after the malfunctioning nozzle information that has been obtained when the image processing parameter has been generated in the previous time, and thus the output stop processing can be carried out using the latest malfunctioning nozzle information. Furthermore, since an increase in an information amount of the malfunctioning nozzle information to be registered into the malfunctioning nozzle information table 80 is suppressed, the capacity of the nozzle ejection correction data storage unit 42 can be reduced.

In addition, with the fourth embodiment as well, since the detection of the malfunctioning nozzle is carried out, respectively, immediately before and while the non-ejection correction LUT is generated, immediately before and while the density non-uniformity correction LUT is generated, and immediately before the print JOB, as in the third embodiment described above, similar effects to those of the first and second embodiments described above can be obtained.

### <Other>

In the fourth embodiment described above, although the malfunctioning nozzle information that has been obtained when the image processing parameter has been generated in the previous time is deleted when the image processing parameter is to be regenerated, at this time, the malfunctioning nozzle information that is obtained immediately before the print JOB may also be subjected to the reset processing at the same time. Furthermore, even in the printing systems 10 and 60 of the first and second embodiments described above, similarly to the fourth embodiment, the reset processing may be carried out on the malfunctioning nozzle information.

### Configuration of Inkjet Printing System of Fifth Embodiment

A printing system of a fifth embodiment of the present invention will now be described. In the printing system 83 of the fourth embodiment described above, when the image processing parameter (the non-ejection correction LUT 46, the density non-uniformity correction LUT 64) is to be regenerated, the malfunctioning nozzle information that has been obtained when the image processing parameter has been generated in the previous time is subjected to the reset processing.

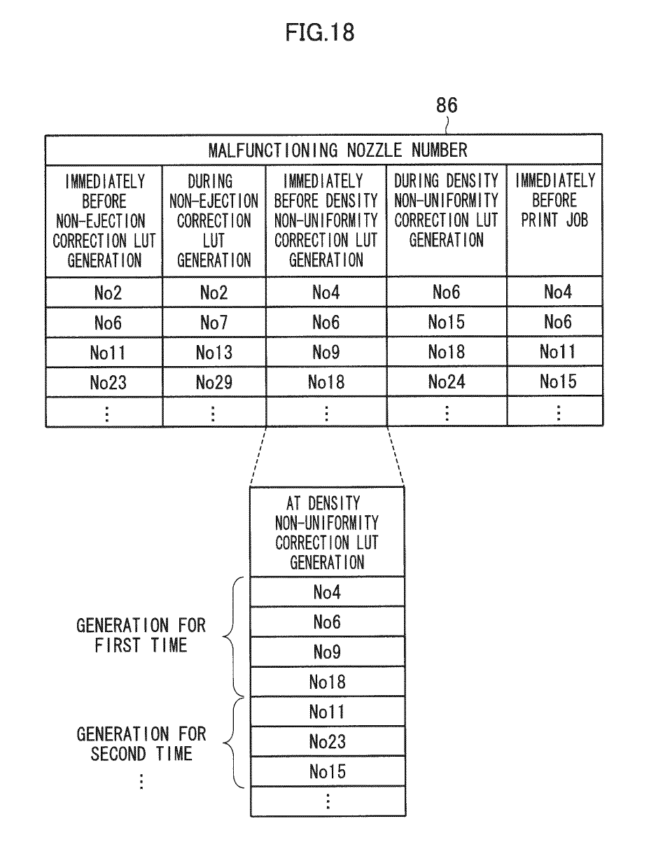

In contrast, as shown in FIG. 18, in the printing system of the fifth embodiment, the malfunctioning nozzle information on a malfunctioning nozzle that is newly detected when the image processing parameter is regenerated is additionally registered (additionally stored) in a malfunctioning nozzle information table 86. In this registration, the malfunctioning nozzle information on all of the detected malfunctioning nozzles may be registered, or only the malfunctioning nozzle information on the malfunctioning nozzles that have not been registered in the malfunctioning nozzle information table 86 may be selectively registered. Furthermore, in FIG. 18, although the malfunctioning nozzle information that is newly obtained when the density non-uniformity correction LUT 64 is regenerated is additionally registered, the malfunctioning nozzle information that is newly obtained when the non-ejection correction LUT 46 is regenerated or immediately before the print JOB is also additionally registered in a similar manner.

It should be noted that the printing system of the fifth embodiment is the same in configuration as the printing system 75 of the third configuration except in the malfunctioning nozzle information table 86. Thus, FIG. 13 should be referred to as for the same configuration as that of the third embodiment.

### Action of Inkjet Printing System of Fifth Embodiment

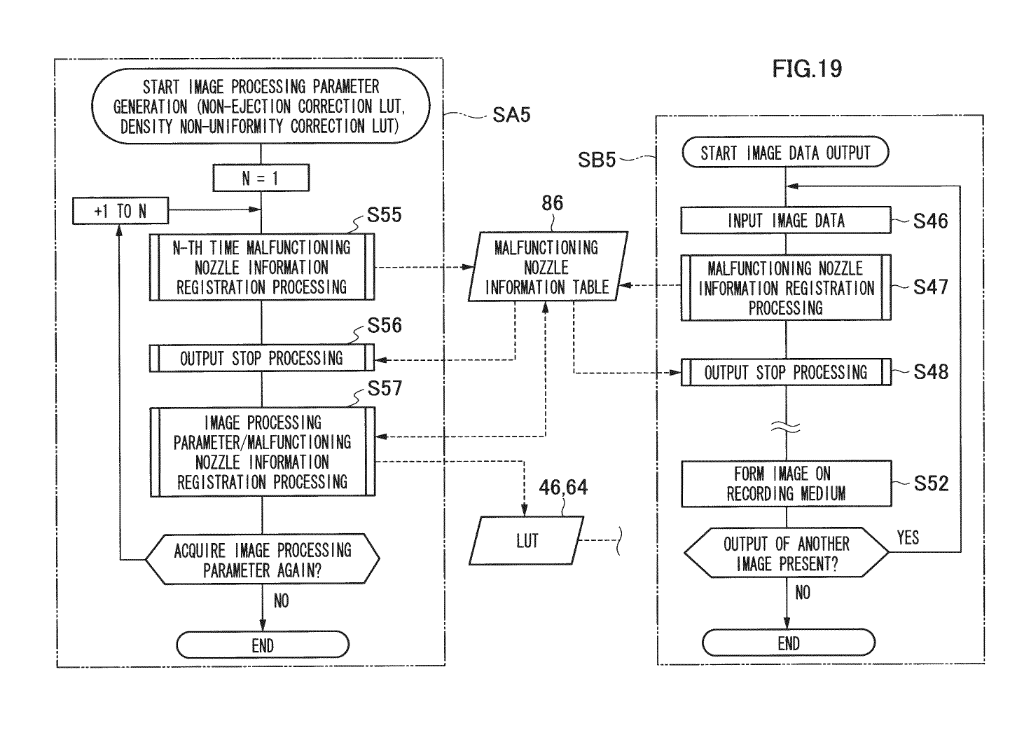

An action of the printing system of the fifth embodiment will be described using a flowchart shown in FIG. 19. It should be noted that an image data output sequence SB5 is the same as the sequence SB3 of the third embodiment, and thus only an “image processing parameter generation sequence SA5 (hereinafter, simply abbreviated to the sequence SA5)” will be described. It should be noted that “N” in FIG. 19 indicates the number of times the image processing parameter (the non-ejection correction LUT 46, the density non-uniformity correction LUT 64) is generated.

In the sequence SA5, basically the same processing as the sequence SA4 is carried out except in that the reset processing (step S58) is omitted from the sequence SA4 of the fourth embodiment shown in FIG. 17. Through this, every time a malfunctioning nozzle is newly detected when the image processing parameter is generated, the malfunctioning nozzle information on the newly detected malfunctioning nozzle is additionally registered into the malfunctioning nozzle information table 86.

It should be note that the malfunctioning nozzle information on a malfunctioning nozzle that is detected immediately before an individual print JOB when printing is to be repeated is also additionally registered into the malfunctioning nozzle information table 86.

### Effects of Fifth Embodiment

In this way, in the fifth embodiment, a nozzle that is detected even once as a malfunctioning nozzle is caused not to eject. Since such a nozzle has a higher possibility of entering a state where ink cannot be ejected continuously than other normal nozzles, keeping that nozzle not to eject makes it possible to suppress generation of a non-uniform streak (see FIGS. 30A and 30B) more reliably.

In addition, with the fifth embodiment as well, since the detection of the malfunctioning nozzle is carried out, respectively, immediately before and while the non-ejection correction LUT is generated, immediately before and while the density non-uniformity correction LUT is generated, and immediately before the print JOB, as in the third embodiment described above, similar effects to those of the first and second embodiments described above can be obtained.

### <Other>

It should be noted that even with the printing systems 10 and 60 of the first and second embodiments described above, similarly to the fifth embodiment, the malfunctioning nozzle information may be additionally registered.

### Configuration of Inkjet Printing System of Sixth Embodiment

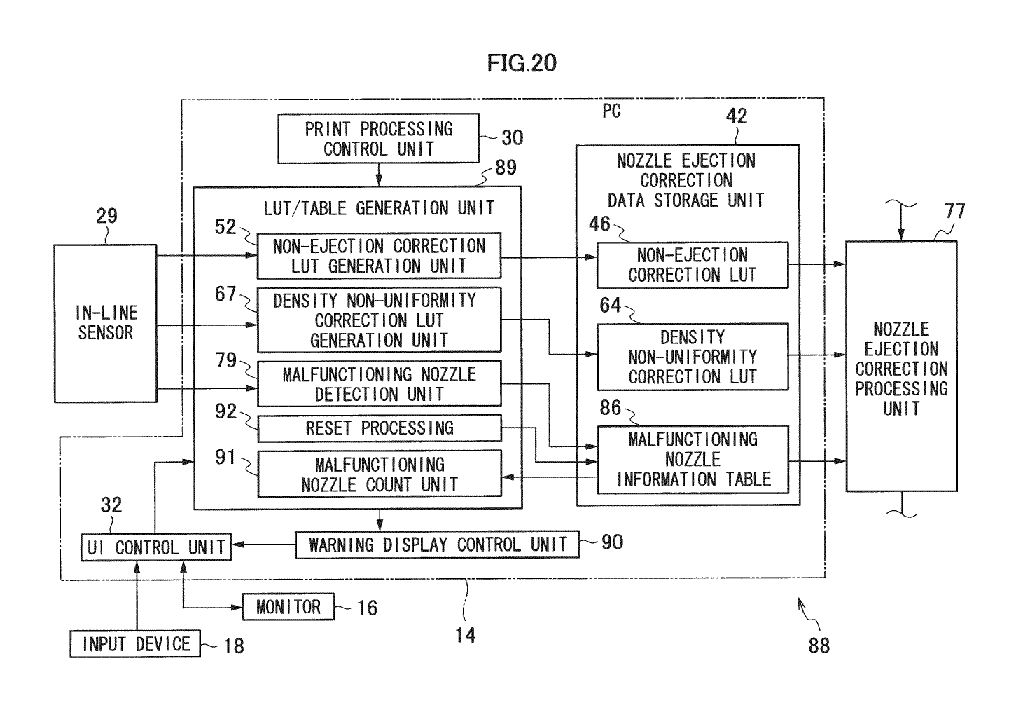

A printing system 88 of a sixth embodiment of the present invention will now be described using FIG. 20. In the inkjet printing system of the fifth embodiment described above, since the malfunctioning nozzle information on the malfunctioning nozzle that is newly detected immediately before and while the image processing parameter is generated is additionally registered into the malfunctioning nozzle information table 86, the malfunctioning nozzle information in the malfunctioning nozzle information table 86 does not decrease. In contrast, the printing system 88 has such a configuration that when the number of pieces of the registered malfunctioning nozzle information reaches or exceeds a predetermined number, the malfunctioning nozzle information in the malfunctioning nozzle information table 86 can be deleted (reset).

The printing system 88 basically has the same configuration as the printing system 75 of the third embodiment except in that the PC 14 includes, in addition to the aforementioned malfunctioning nozzle information table 86, an LUT/table generation unit 89 and a warning display control unit (the warning display device) 90, and thus items that are the same in terms of the function and the configuration as those in the third embodiment described above will be given the same reference characters, and the description thereof will be omitted.

The LUT/table generation unit 89 includes, in addition to the non-ejection correction LUT generation unit 52, the density non-uniformity correction LUT generation unit 67, and the malfunctioning nozzle detection unit 79 described above, a malfunctioning nozzle count unit (a count device) 91 and a reset processing unit (a second information deletion device) 92.

The malfunctioning nozzle count unit 91 operates each time new malfunctioning nozzle information is registered in the malfunctioning nozzle information table 86 to count the number of pieces of the malfunctioning nozzle information registered in the malfunctioning nozzle information table 86, in other words, the number of the malfunctioning nozzles. The count result of the malfunctioning nozzles by the malfunctioning nozzle count unit 91 is inputted to the warning display control unit 90.

When the number of the malfunctioning nozzles counted by the malfunctioning nozzle count unit 91 reaches or exceeds a predetermined number, the warning display control unit 90 controls the UI control unit 32 to cause a warning display indicating that the number of the malfunctioning nozzles has reached or exceeded the predetermined number (a warning message or the like) to be displayed on the monitor 16.

After the warning is displayed on the monitor 16 and when a predetermined operation to cause the detection of the malfunctioning nozzle (registration of the malfunctioning nozzle information) to be carried out (hereinafter, referred to as a malfunctioning nozzle detection operation) is carried out, the reset processing unit 92 carried out reset processing to delete at least a part of the malfunctioning nozzle information that is registered in the malfunctioning nozzle information table 86. It should be noted that the “malfunctioning nozzle detection operation” referred to here, for example, is an operation to start the malfunctioning nozzle information registration processing, an operation to start the non-ejection correction LUT generation processing, an operation to start the density non-uniformity correction LUT generation processing, and so on.

In a case where, for example, the malfunctioning nozzle detection operation is carried out when the non-ejection correction LUT generation processing is repeatedly carried out, the reset processing unit 92 carries out the reset processing on the malfunctioning nozzle information under the columns “immediately before non-ejection correction LUT generation” and “during non-ejection correction LUT generation” of the malfunctioning nozzle information table 86. Further, in a case where, for example, the malfunctioning nozzle detection operation is carried out when the density non-uniformity correction LUT generation processing is repeatedly carried out, the reset processing unit 92 carries out the reset processing on the malfunctioning nozzle information under the columns “immediately before density non-uniformity correction LUT generation” and “during density non-uniformity correction LUT generation” of the malfunctioning nozzle information table 86.

It should be noted that when the malfunctioning nozzle detection operation is carried out, instead of carrying out the reset processing on the malfunctioning nozzle information in either one of the columns “immediately before non-ejection correction LUT generation” and “during non-ejection correction LUT generation” and the columns “immediately before density non-uniformity correction LUT generation” and “during density non-uniformity correction LUT generation,” the reset processing may be carried out on the malfunctioning nozzle information in both. In addition, when the reset processing is carried out on the malfunctioning nozzle information in at least one of the columns “immediately before non-ejection correction LUT generation” and “during non-ejection correction LUT generation” and the columns “immediately before density non-uniformity correction LUT generation” and “during density non-uniformity correction LUT generation”, the reset processing may also be carried out on the malfunctioning nozzle information under the column “immediately before print JOB” at the same time.

### Action of Inkjet Printing System of Sixth Embodiment

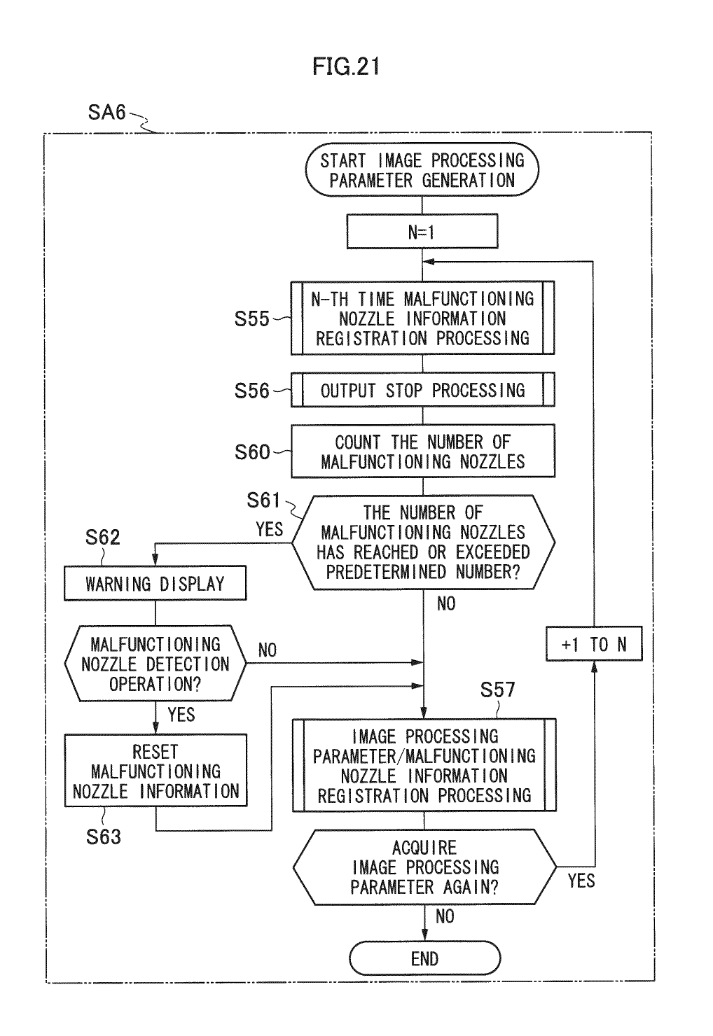

An action of the printing system 88 of the sixth embodiment will be described using a flowchart shown in FIG. 21. It should be noted that an image data output sequence is basically the same as those of the third to fifth embodiments described above, and thus only an “image processing parameter generation sequence SA6 (hereinafter, simply abbreviated to the sequence SA6)” will be described.

The sequence SA6 is basically the same as the sequence SA5 of the fifth embodiment shown in FIG. 19, and steps S55 to S57 are repeatedly carried out when the image processing parameter (the non-ejection correction LUT 46, the density non-uniformity correction LUT 64) is regenerated. Through this, malfunctioning nozzle information on a newly detected malfunctioning nozzle is additionally registered into the malfunctioning nozzle information table 86.

In addition, in the sequence SA6, each time a new piece of malfunctioning nozzle information is registered into the malfunctioning nozzle information table 86, the malfunctioning nozzle count unit 91 refers to the malfunctioning nozzle information table 86 to count the number of the malfunctioning nozzles (step S60). The count result of the malfunctioning nozzles by the malfunctioning nozzle count unit 91 is successively inputted to the warning display control unit 90.

The warning display control unit 90 determines whether or not the number of the malfunctioning nozzles has reached or exceeded a predetermined number based on the count result of the number of the malfunctioning nozzles that is inputted from the malfunctioning nozzle count unit 91 (step S61). Then, when the number of the malfunctioning nozzles is less than the predetermined number, the display warning control unit 90 enters a standby state.

On the other hand, when the number of the malfunctioning nozzles has reached or exceeded the predetermined number, the warning display control unit 90 causes a warning display indicating to that effect to be displayed on the monitor 16 (step S62). This makes it possible to prompt an operator to carry out the malfunctioning nozzle detection operation (an operation to start the malfunctioning nozzle information registration processing, the non-ejection correction LUT generation processing, the density non-uniformity correction LUT generation processing, and so on).

After the warning is displayed on the monitor 16, when the malfunctioning nozzle detection operation described above is carried out, the reset processing unit 92 operates. Through this, when, for example, the non-ejection correction LUT generation processing is repeatedly carried out, the reset processing is carried out on the malfunctioning nozzle information under the columns “immediately before non-ejection correction LUT generation” and “during non-ejection correction LUT generation,” and when the density non-uniformity correction LUT generation processing is repeatedly carried out, the reset processing is carried out on the malfunctioning nozzle information under the columns “immediately before density non-uniformity correction LUT generation” and “during density non-uniformity correction LUT generation” (step S63).

It should be noted that, although not shown in the drawings, in the image processing parameter/malfunctioning nozzle information registration processing (step S57) and the malfunctioning nozzle information registration processing of the image data output sequence (step S47, see FIG. 19) as well, processing in steps S60 to S63 described above may be carried out.

After the reset processing of the malfunctioning nozzle information, if it is determined that the image processing parameter is again to be regenerated, the above-described processing is repeatedly carried out.

### Effects of Sixth Embodiment

In this way, in the sixth embodiment, when the number of pieces of the malfunctioning nozzle information that is registered in the malfunctioning nozzle information table 86 has reached or exceeded the predetermined number, at least a part of the malfunctioning nozzle information in the malfunctioning nozzle information table 86 can be deleted. As a result, an increase in an information amount of the malfunctioning nozzle information to be registered in the malfunctioning nozzle information table 86 is suppressed, and thus the capacity of the nozzle ejection correction data storage unit 42 can be reduced. In addition, similar effects as those of the first and second embodiments described above can be obtained as well.

### <Other>

In the sixth embodiment described above, although when the number of the malfunctioning nozzles has reached or exceeded the predetermined number, the warning display indicating to that effect is displayed on the monitor 16, as the warning display, various warning displays such as an audio guide using a speaker may be carried out.

Furthermore, in a case where the malfunctioning nozzle information is additionally registered in the printing systems 10 and 60 of the first and second embodiments described above similarly to the fifth embodiment, as in the sixth embodiment, the warning display and the reset processing of the malfunctioning nozzle information may be carried out.

### Configuration of Inkjet Printing System of Seventh Embodiment

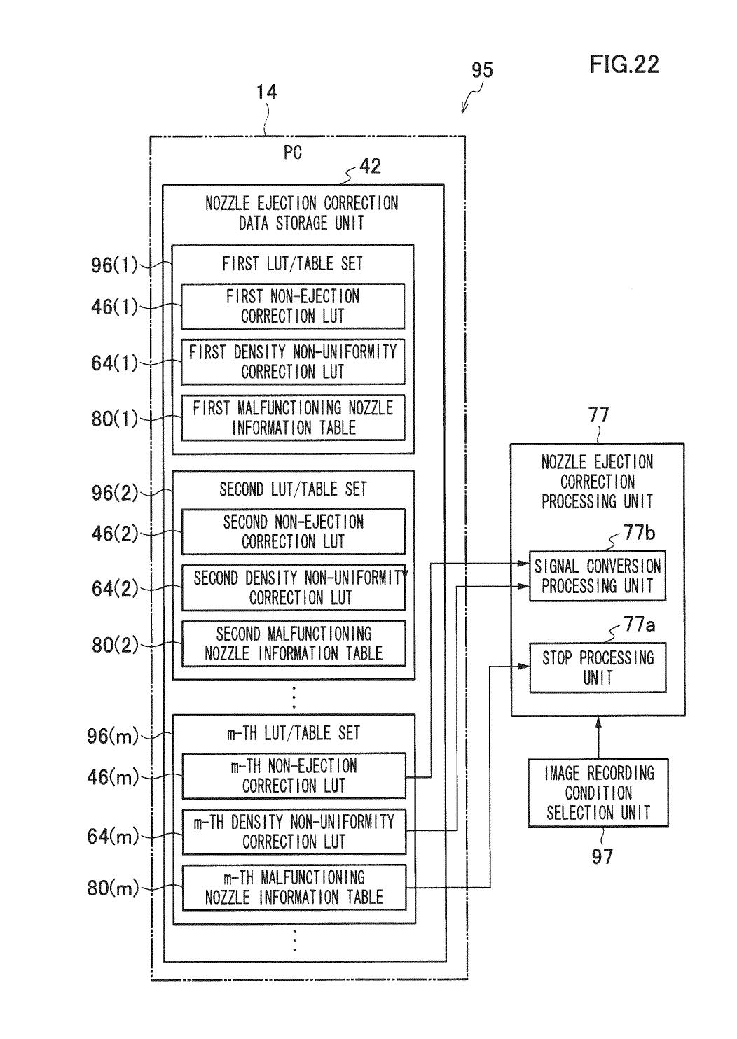

A printing system 95 of a seventh embodiment of the present invention will now be described using FIG. 22. The printing system 95 differs from the printing systems of the above-described embodiments in that the image processing parameter (the non-ejection correction LUT 46, the density non-uniformity correction LUT 64) is generated and stored for each image recording condition such as the type of the recording medium P and the type of a halftone dot (halftone) (hereinafter, simply referred to as the image recording condition).

The printing system 95 basically has the same configuration as the printing system 75 of the third embodiment except in that a plurality of types of image processing parameters are stored in the nozzle ejection correction data storage unit 42, and thus items that are the same in terms of the function and the configuration as those in the third embodiment described above will be given the same reference characters, and the description thereof will be omitted.

A plurality of types of LUT/table sets [a first LUT/table set 96(1), a second LUT/table set 96(2), . . . , and an m-th LUT/table set 96(m)] are stored in the nozzle ejection correction data storage unit 42.

The non-ejection correction LUT 46, the density non-uniformity correction LUT 64, and the malfunctioning nozzle information table 80 that are generated for each image recording condition are stored in each of the LUT/table sets 96(1) to 96(m).

For example, a first non-ejection correction LUT 46(1), a first density non-uniformity correction LUT 64(1), and a first malfunctioning nozzle information table 80(1) that correspond to a first image recording condition (for example, a first recording medium P and/or a first halftone, not shown) are stored in the first LUT/table set 96(1). Similarly, an m-th non-ejection correction LUT 46(m), an m-th density non-uniformity correction LUT 64(m), and an m-th malfunctioning nozzle information table 80(m) that correspond to an m-th image recording condition (for example, an m-th recording medium P and/or an m-th halftone, not shown) are stored in the m-th LUT/table set 96(m). In other words, the image processing parameters (the correction values) for the respective image recording conditions and the malfunctioning nozzle information tables for the respective image recording conditions are stored being associated with each other.

It should be noted that generation procedures of the non-ejection correction LUTs 46(1) to 46(m), the density non-uniformity correction LUTs 64(1) to 64(m), and the malfunctioning nozzle information tables 80(1) to 80(m) under the respective image recording conditions are basically the same as those in the third embodiment described above, and thus the description thereof will be omitted here.

The nozzle ejection correction processing unit 77 of the printing system 95 acquires the image processing parameter (the non-ejection correction LUT, the density non-uniformity correction LUT) and the malfunctioning nozzle information table 80 that correspond to the image recording condition selected by an image recording condition selection unit 97 (or can be the input device 18 of the PC 14) corresponding to an image recording condition selection device of the present invention. The stop processing unit 77a acquires the malfunctioning nozzle information table 80 corresponding to the image recording condition. The signal conversion processing unit 77b acquires the image processing parameter (the non-ejection correction LUT 46, the density non-uniformity correction LUT 64) corresponding to the image recording condition.

Further, each of the LUT/table sets 96(1) to (m) of the respective image recording conditions is used not only independently from each other but also in combination of a plurality of the image recording conditions, in other words, a combination of two or more of the LUT/table sets 96(1) to 96(m) may be used. In this case, the nozzle ejection correction processing unit 77 (the stop processing unit 77a, the signal conversion processing unit 77b) acquires a plurality of image processing parameters (the non-ejection correction LUTs, the density non-uniformity correction LUTs) and a plurality of malfunctioning nozzle information tables that correspond to a plurality of image recording conditions selected at the time of the image data output sequence. It should be noted that when a specific image recording condition is selected at the time of the image data output sequence, a plurality of LUT/table sets (the image processing parameters, the malfunctioning nozzle information tables) may be acquired to be used in combination.

### Action of Inkjet Printing System of Seventh Embodiment

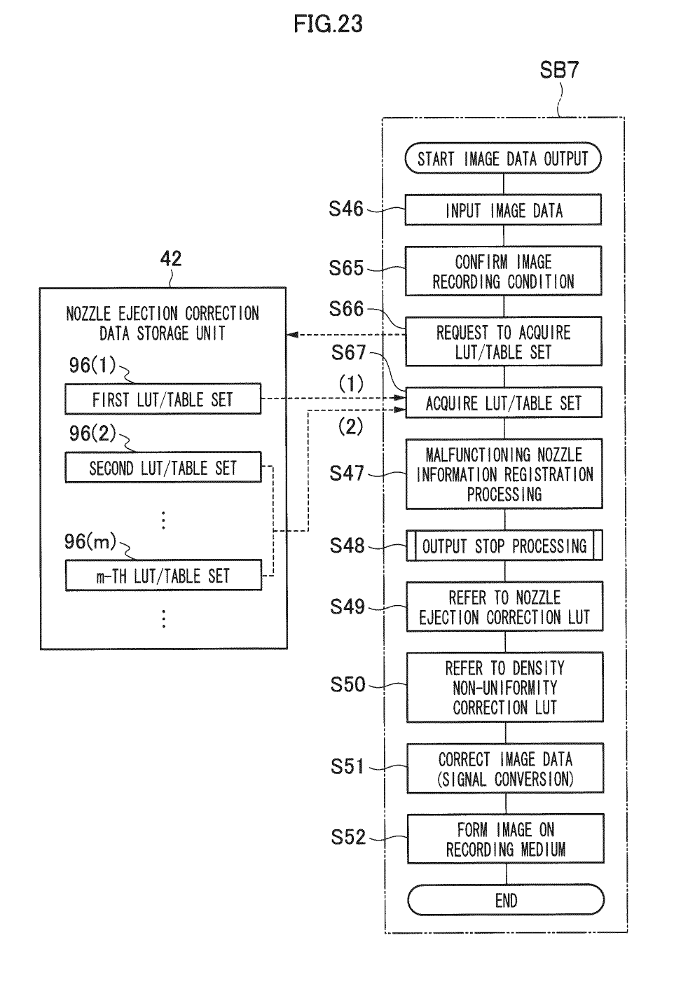

An action of the printing system 95 of the seventh embodiment, in particular, an image data output sequence SB7 (hereinafter, simply abbreviated to the sequence SB7) will be described using a flowchart shown in FIG. 23. It should be noted that an image processing parameter generation sequence is the same as the sequence SA3 of the third embodiment except in that the non-ejection correction LUT 46, the density non-uniformity correction LUT 64, and the malfunctioning nozzle information table 80 are generated and stored for each image recording condition selected in advance by the image recording condition selection unit 97, and thus the description thereof will be omitted herein.

The sequence SB7 is basically the same as the sequence SB3 of the third embodiment, but steps S65, S66, and S67 described below are carried out.

In step S65, for example, the nozzle ejection correction processing unit 77 (or can be the print processing control unit 30 of the PC 14 or the like) confirms an image recording condition selected in advance by the image recording condition selection unit 97.

In step S66, the nozzle ejection correction processing unit 77 (the stop processing unit 77a, the signal conversion processing unit 77b) requests to acquire the LUT/table set (each correction LUT/malfunctioning nozzle information table) that corresponds to each image recording condition based on the confirmation result of the image recording condition. This acquisition request is, for example, for a set number of each of the LUT/table sets 96(1) to 96(m).

At this point, if only one image recording condition has been selected by the image recording condition selection unit 97, a single corresponding set number among the LUT/table sets 96(1) to 96(m) is sent to the nozzle ejection correction data storage unit 42. Further, when a plurality of image recording conditions have been selected, or when an image recording condition in which a plurality of LUT/table sets (the image processing parameter and the malfunctioning nozzle information table) are to be used in combination is selected, a plurality of corresponding set numbers among the LUT/table sets 96(1) to 96(m) are sent to the nozzle ejection correction data storage unit 42.

In step S67, an LUT/table set that corresponds to the acquisition request of the LUT/table generation unit 78 among the LUT/table sets 96(1) to 96(m) is sent to the nozzle ejection correction processing unit 77. At this point, as indicated by the parenthetical number (1), when the acquisition request is only for a single LUT/table set, a single LUT/table set that corresponds to the acquisition request among the LUT/table sets 96(1) to 96(m) is sent to the nozzle ejection correction processing unit 77.

Furthermore, as indicated by the parenthetical number (2), when the acquisition request is for a plurality of LUT/table sets, a plurality of LUT/table sets that correspond to the acquisition request among the LUT/table sets 96(1) to 96(m) are sent to the nozzle ejection correction processing unit 77. In other words, each nozzle can be determined to be put in non-ejecting state in accordance with a combination of the image recording conditions (the image processing parameters) to be used.

In this way, at least one of the non-ejection correction LUTs 46(1) to 46(m), at least one of the density non-uniformity correction LUTs 64(1) to 64(m), and at least one of the malfunctioning nozzle information tables 80(1) to 80(m) that correspond to the respective image recording conditions are set in the stop processing unit 77a and the signal conversion processing unit 77b of the nozzle ejection correction processing unit 77.

It should be noted that the processing in steps S65 to S67 described above may be carried out before and after the image data is inputted (step S7).

Thereafter, similarly to the third embodiment described above, the output stop processing, the image data correction (the signal conversion), and the image formation by the marking unit 28 are carried out. However, in step S47, the output stop processing is carried out based on the malfunctioning nozzle information table acquired in step S67, and in steps S49 to S51, the signal conversion processing is carried out based on the non-ejection correction LUT and the density non-uniformity correction LUT acquired in step S67.

### Effects of Seventh Embodiment

In this way, in the seventh embodiment, the image formation is carried out using the image processing parameter and the malfunctioning nozzle information table that are generated for each image recording condition, and thus an image of a higher quality than that of the third embodiment can be formed. Furthermore, similar effects as those of the first and second embodiments described above can be obtained.

In addition, the output of a malfunctioning nozzle can be stopped based on information in which the malfunctioning nozzle information pieces on the plurality of malfunctioning nozzle information tables are combined in accordance with a combination of the image recording conditions (the image processing parameters) to be used. Through this, a nozzle to be subjected to the output stop processing can be changed in accordance with the combination of the image recording conditions to be used, and thus an image of even higher quality can be formed.

### Another Embodiment of Seventh Embodiment (Third Embodiment)

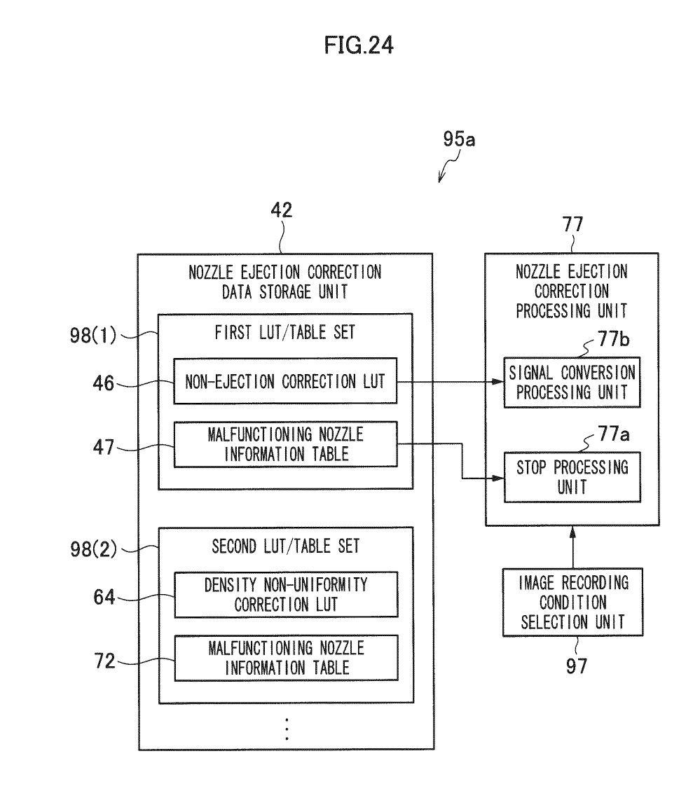

A printing system 95a of another embodiment of the seventh embodiment (the third embodiment) described above will now be described using FIG. 24. In the seventh embodiment (the third embodiment) described above, both of the non-uniform streak correction and the density non-uniformity correction are carried out. In contrast, with the printing system 95a, the non-uniform streak correction and/or the density non-uniformity correction are/is selectively carried out as an image recording condition, and a non-ejecting state of each nozzle is switched in accordance with the selection.

It should be noted that the printing system 95a basically has the same configuration as the printing system 75 of the third embodiment, the printing system 95 of the seventh embodiment, and so on, and items that are the same in terms of the function and the configuration as those in the first to seventh embodiments described above will be given the same reference characters, and the description thereof will be omitted.

The nozzle ejection correction data storage unit 42 of the printing system 95a stores at least a first LUT/table set 98(1) to be used at the time of the non-uniform streak correction and a second LUT/table set 98(2) to be used at the time of the density non-uniformity correction. The non-ejection correction LUT 46 and the malfunctioning nozzle information table 47 (see FIG. 2) are stored in the first LUT/table set 98(1). Further, the density non-uniformity correction LUT 64 and the malfunctioning nozzle information table 72 (see FIG. 8) are stored in the second LUT/table set 98(2).

It should be noted that generation procedures of the non-ejection correction LUT 46, the density non-uniformity correction LUT 64, and the malfunctioning nozzle information tables 47 and 72 are basically the same as those in first and second embodiments described above, and thus the description thereof will be omitted here.

When an image recording condition in which the non-uniform streak correction is carried out but the density non-uniformity correction is not carried out is selected by the image recording condition selection unit 97, the nozzle ejection correction processing unit 77 acquires the first LUT/table set 98(1). To be more specific, the stop processing unit 77a acquires the malfunctioning nozzle information table 47, and the signal conversion processing unit 77b acquires the non-ejection correction LUT 46. Through this, similarly to the first embodiment described above, the output stop processing of the malfunctioning nozzles registered in the malfunctioning nozzle information table 47, the image data correction (the signal conversion), and the image formation by the marking unit 28 are carried out.

Although not shown in the drawings, when an image recording condition in which the density non-uniformity correction is carried out but the non-uniform streak correction is not carried out is selected by the image recording condition selection unit 97, the nozzle ejection correction processing unit 77 acquires the second LUT/table set 98(2). To be more specific, the stop processing unit 77a acquires the malfunctioning nozzle information table 72, and the signal conversion processing unit 77b acquires the density non-uniformity correction LUT 64. Through this, similarly to the second embodiment described above, the output stop processing of the malfunctioning nozzles registered in the malfunctioning nozzle information table 72, the image data correction (the signal conversion), and the image formation by the marking unit 28 are carried out.

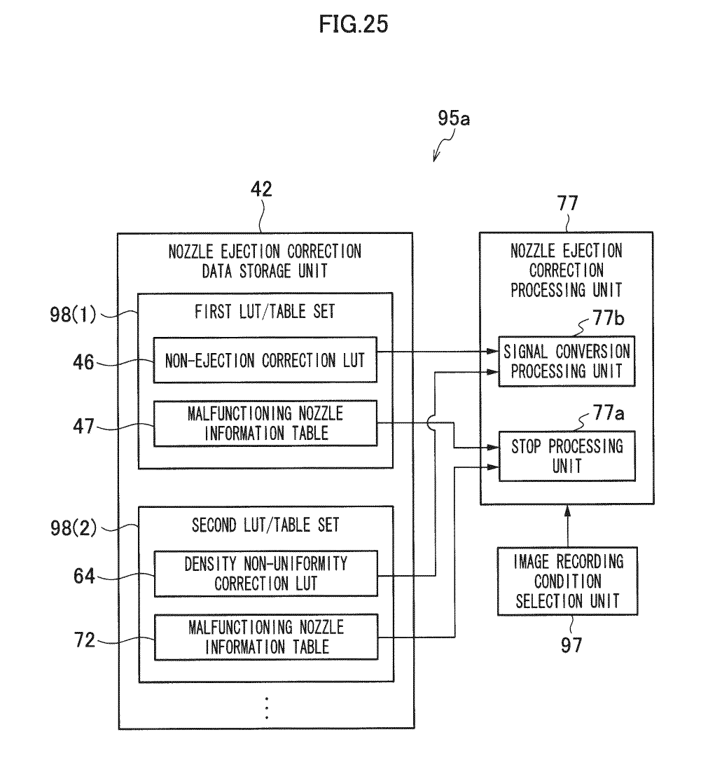

As shown in FIG. 25, when an image recording condition in which both of the non-uniform streak correction and the density non-uniformity correction are carried out is selected by the image recording condition selection unit 97, the nozzle ejection correction processing unit 77 acquires the first and second LUT/table sets 98(1) and 98(2). The stop processing unit 77a acquires the malfunctioning nozzle information tables 47 and 72, and the signal conversion processing unit 77b acquires the non-ejection correction LUT 46 and the density non-uniformity correction LUT 64.

The stop processing unit 77a carries out the output stop processing of a malfunctioning nozzle based on information in which the malfunctioning nozzle information pieces registered in the malfunctioning nozzle information tables 47 and 72 are combined. Through this, the malfunctioning nozzles registered in each of the malfunctioning nozzle information tables 47 and 72, in other words, a malfunctioning nozzle registered in at least one of the malfunctioning nozzle information tables 47 and 72 is caused not to eject.

### <Effects>

In this way, the output of a malfunctioning nozzle can be stopped based on the malfunctioning nozzle information of a single malfunctioning nozzle information table or information in which the malfunctioning nozzle information pieces of a plurality of malfunctioning nozzle information tables are combined in accordance with a combination of the image recording conditions (the non-uniform streak correction, the density non-uniformity correction) selected by the image recording condition selection unit 97. Through this, a nozzle to be subjected to the output stop processing can be changed in accordance with the combination of the image recording conditions to be used, and thus an image of even higher quality can be formed.

It should be noted that although the two types of the first and second LUT/table sets 98(1) and 98(2) that are stored in the nozzle ejection correction data storage unit 42 are described in the embodiment of FIGS. 24 and 25, a plurality of LUT/table sets may further be provided in accordance with the type of the recording medium P, the type of the halftone dot (halftone), and so on.

### <Other>

Furthermore, the image recording condition is not limited to the type of the recording medium P, the type of the halftone dot (halftone), or present/absence of execution of the non-uniform streak correction and the density non-uniformity correction and includes other image recording conditions.

### <Configuration Example of Inkjet Recording Apparatus>

A configuration example of an inkjet recording apparatus as an example of the printer 12 shown in FIG. 1 will now be described.

As shown in FIG. 26, an inkjet recording apparatus 100 employs a direct image formation method, which forms a desired color image by ejecting and depositing droplets of inks of a plurality of colors from inkjet heads 172M, 172K, 172C, and 172Y (corresponding to the inkjet heads 27 of the above-described embodiments) onto the recording medium P (hereinafter, referred to as “paper” in some cases) held on an image formation drum 170. The inkjet recording apparatus 100 is an image forming apparatus of drop on-demand type employing a two-liquid reaction (aggregation) method in which an image is formed on the recording medium P by depositing a treatment liquid (here, an aggregation treatment liquid) on the recording medium P before depositing droplets of the inks, and causing the treatment liquid and the ink liquid to react together.

The inkjet recording apparatus 100 includes a paper feed unit 112, a treatment liquid deposition unit 114, the image formation unit 116, a drying unit 118, a fixing unit 120 and a paper output unit 122.

<<Paper Supply Unit>>

The recording media P which are cut sheets of paper are stacked in the paper supply unit 112. The recording medium P is supplied to the treatment liquid deposition unit 114, one sheet at a time, from a paper supply tray 150 of the paper supply unit 112. The cut sheets of paper are used as the recording media P here, and it is also possible to adopt a composition in which paper is supplied from a continuous roll (rolled paper) and is cut to the required size.

<<Treatment Liquid Deposition Unit>>

The treatment liquid deposition unit 114 is a mechanism which deposits the treatment liquid onto a recording surface of the recording medium P. The treatment liquid includes a coloring material aggregating agent, which aggregates the coloring material (in the present embodiment, the pigment) in the ink deposited by the image formation unit 116, and the separation of the ink into the coloring material and the solvent is promoted due to the treatment liquid and the ink making contact with each other.

The treatment liquid deposition unit 114 includes a paper supply drum 152, a treatment liquid drum 154 and a treatment liquid application device 156. The treatment liquid drum 154 has a hook-shaped gripping device (gripper) 155 arranged on the outer circumferential surface thereof, and is devised in such a manner that the leading end of the recording medium P can be held by gripping the recording medium P between the hook of the gripping device 155 and the circumferential surface of the treatment liquid drum 154. The treatment liquid drum 154 can have suction holes arranged in the outer circumferential surface thereof, which are connected to a suction device configured to perform suction through the suction holes. By this means, it is possible to hold the recording medium 124 tightly against the circumferential surface of the treatment liquid drum 154.

The treatment liquid application device 156 is disposed so as to oppose the circumferential surface of the treatment liquid drum 154. The treatment liquid application device 156 includes: a treatment liquid vessel, in which the treatment liquid is stored; an anilox roller (metering roller), which is partially immersed in the treatment liquid in the treatment liquid vessel; and a rubber roller, which transfers a dosed amount of the treatment liquid to the recording medium P, by being pressed against the anilox roller and the recording medium P on the treatment liquid drum 154. According to the treatment liquid application device 156, it is possible to apply the treatment liquid to the recording medium P while dosing the amount of the treatment liquid. In the present embodiment, the composition is described which uses the roller-based application method, but the method is not limited to this, and it is also possible to employ various other methods, such as a spray method, an inkjet method, or the like.

The recording medium P onto which the treatment liquid has been deposited is transferred from the treatment liquid drum 154 to an image formation drum 170 of the image formation unit 116 through an intermediate conveyance unit 126.

<<Image Formation Unit>>

The image formation unit 116 includes the image formation drum 170, a paper pressing roller 174, and the inkjet heads 172M, 172K, 172C and 172Y. Similarly to the treatment liquid drum 154, the image formation drum 170 has a hook-shaped holding device (gripper) 171 on the outer circumferential surface thereof.

The inkjet heads 172M, 172K, 172C and 172Y are full-line type inkjet recording heads, each of which has a length corresponding to the maximum width of the image forming region on the recording medium P, and a row of nozzles for ejecting ink arranged throughout the whole width of the image forming region is formed in the ink ejection surface of each head. The inkjet heads 172M, 172K, 172Y and 172Y are disposed so as to extend in a direction perpendicular to the conveyance direction of the recording medium P (the direction of rotation of the image formation drum 170).

When droplets of the corresponding colored ink are ejected and deposited from the inkjet heads 172M, 172K, 172C and 172Y to the recording surface of the recording medium P which is held tightly on the image formation drum 170, the deposited ink makes contact with the treatment liquid which has previously been deposited on the recording surface by the treatment liquid deposition unit 114, the coloring material (pigment) dispersed in the ink is aggregated, and a coloring material aggregate is thereby formed. Thereby, flowing of the coloring material, and the like, on the recording medium P is prevented and an image is formed on the recording surface of the recording medium P.

Thus, the recording medium P is conveyed at a constant speed by the image formation drum 170, and it is possible to record an image on the image forming region of the recording medium P by performing just one operation (or one sub-scanning operation) of moving the recording medium P relatively to the inkjet heads 172M, 172K, 172C and 172Y in the conveyance direction.

The recording medium P onto which the image has been formed in the image formation unit 116 is transferred from the image formation drum 170 to a drying drum 176 of the drying unit 118 through an intermediate conveyance unit 128.

<<Drying Unit>>

The drying unit 118 is a mechanism which dries the water content contained in the solvent which has been separated by the action of aggregating the coloring material. The drying unit 118 includes the drying drum 176 and a solvent drying device 178. Similarly to the treatment liquid drum 154, the drying drum 176 has a hook-shaped holding device (gripper) 177 arranged on the outer circumferential surface thereof, in such a manner that the leading end of the recording medium P can be held by the holding device 177.

The solvent drying device 178 is disposed in a position opposing the outer circumferential surface of the drying drum 176, and is constituted of a plurality of halogen heaters 180 and hot air spraying nozzles 182 disposed respectively between the halogen heaters 180. The recording medium P on which a drying process has been carried out in the drying unit 118 is transferred from the drying drum 176 to a fixing drum 184 of the fixing unit 120 through an intermediate conveyance unit 130.

<<Fixing Unit>>

The fixing unit 120 includes the fixing drum 184, a halogen heater 186, a fixing roller 188 and an in-line sensor 190. Similarly to the treatment liquid drum 154, the fixing drum 184 has a hook-shaped holding device (gripper) 185 arranged on the outer circumferential surface thereof, in such a manner that the leading end of the recording medium P can be held by the holding device 185.

By means of the rotation of the fixing drum 184, the recording surface of the recording medium P is subjected to a preliminary heating process by the halogen heater 186, a fixing process by the fixing roller 188, and inspection by the in-line sensor 190.

The fixing roller 188 is a roller member for melting self-dispersing polymer micro-particles contained in the ink and thereby causing the ink to form a film, by applying heat and pressure to the dried ink, and is composed so as to apply heat and pressure to the recording medium P. More specifically, the fixing roller 188 is disposed so as to press against the fixing drum 184, in such a manner that a nip is created between the fixing roller 188 and the fixing drum 184. The recording medium P is interposed between the fixing roller 188 and the fixing drum 184 and is nipped with a prescribed nip pressure, whereby a fixing process is carried out.

Furthermore, the fixing roller 188 is constituted of a heated roller which incorporates a halogen lamp, or the like, and is controlled to a prescribed temperature.

The in-line sensor 190 is a device for reading in the image formed on the recording medium P (including a test chart of the above-described embodiments, or the like) and determining the density of the image, defects in the image, and so on. A CCD (charge-coupled device) line sensor, or the like, is employed for the in-line sensor 190.

According to the fixing unit 120, the latex particles in the thin image layer formed by the drying unit 118 are heated, pressurized and melted by the fixing roller 188, and hence the image layer can be fixed to the recording medium P. Furthermore, the surface temperature of the fixing drum 184 is set to be not lower than 50° C. Drying is promoted by heating the recording medium P held on the outer circumferential surface of the fixing drum 184 from the rear surface, and therefore breaking of the image during fixing can be prevented, and furthermore, the strength of the image can be increased by the effects of the increased temperature of the image.

Instead of the ink which includes a high-boiling-point solvent and polymer micro-particles (thermoplastic resin particles), it is also possible to include a monomer which can be polymerized and cured by exposure to ultraviolet (UV) light. In this case, the inkjet recording apparatus 100 includes a UV exposure unit for exposing the ink on the recording medium P to UV light, instead of the heat and pressure fixing unit (fixing roller 188) based on the heat roller. In this way, if using an ink containing an active light-curable resin, such as a ultraviolet-curable resin, a device which irradiates the active light, such as a UV lamp or an ultraviolet LD (laser diode) array, is arranged instead of the fixing roller 188 for heat fixing.

<<Paper Output Unit>>

The paper output unit 122 is arranged subsequently to the fixing unit 120. The paper output unit 122 includes an output tray 192, and a transfer drum 194, a conveyance belt 196 and a tensioning roller 198 are arranged between the output tray 192 and the fixing drum 184 of the fixing unit 120 so as to oppose same. The recording medium P is sent to the conveyance belt 196 by the transfer drum 194 and outputted to the output tray 192. The details of the paper conveyance mechanism created by the conveyance belt 196 are not shown, but the leading end portion of the recording medium P after the printing is held by a gripper on a bar (not shown) which spans between the endless conveyance belts 196, and the recording medium 124 is conveyed over the output tray 192 due to the rotation of the conveyance belts 196.

Furthermore, although not shown in figure, the inkjet recording apparatus 100 according to the present embodiment includes, in addition to the composition described above: an ink storing and loading unit, which supplies the inks to the inkjet heads 172M, 172K, 172C and 172Y; a device which supplies the treatment liquid to the treatment liquid deposition unit 114; a head maintenance unit which carries out cleaning (nozzle surface wiping, purging, nozzle suctioning, and the like) of the inkjet heads 172M, 172K, 172C and 172Y; a position determination sensor, which determines the position of the recording medium 124 in the paper conveyance path; a temperature sensor which determines the temperature of the respective units of the inkjet recording apparatus 100, and the like.

### <Composition of Inkjet Head>

Next, the structure of the inkjet head is described. The inkjet heads 172M, 172K, 172C and 172Y have a common structure, and therefore these heads are represented by a head denoted with reference numeral 250 below.

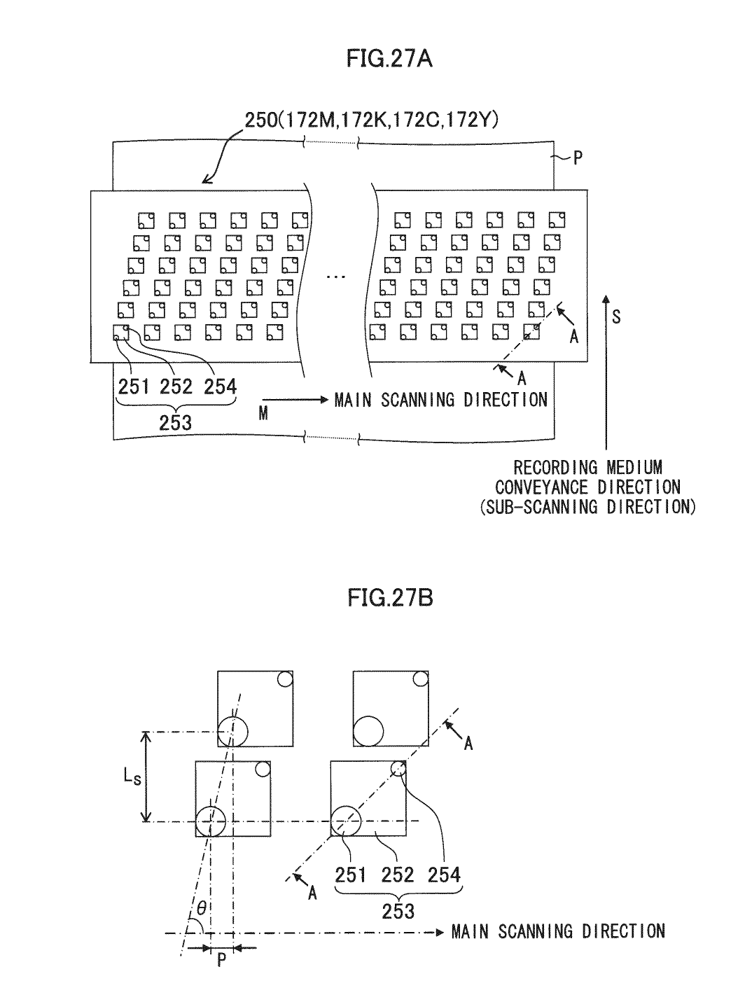

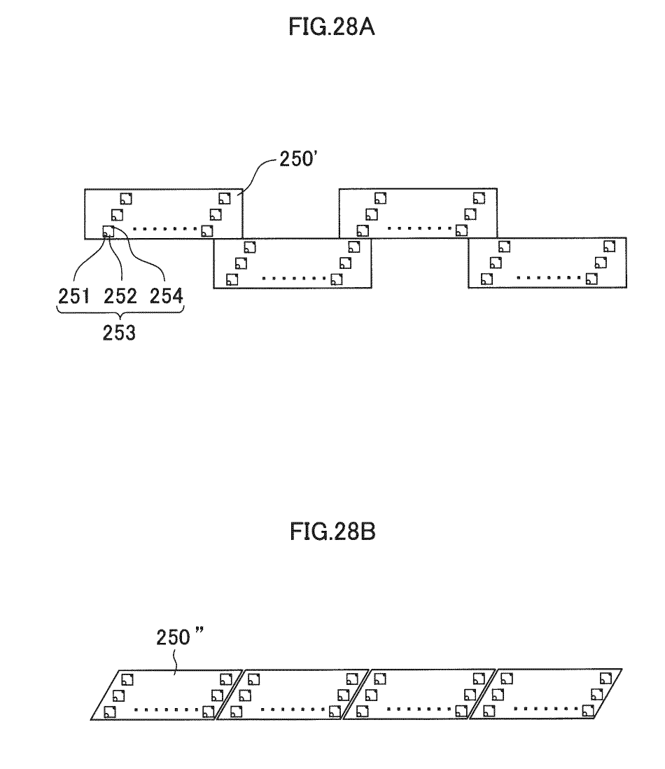

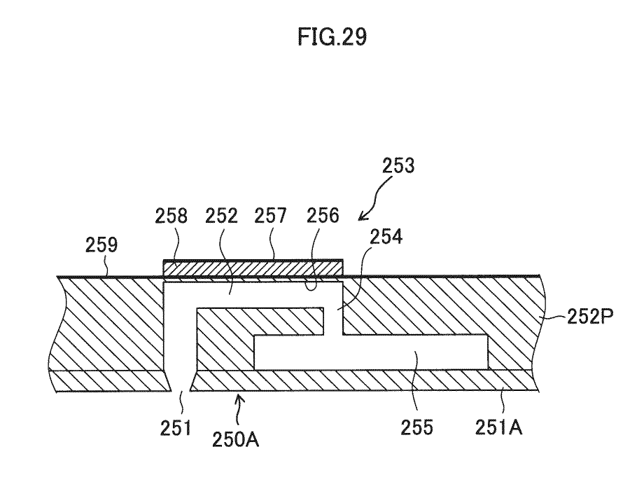

FIG. 27A is a plan view perspective diagram showing an example of the structure of the head 250, and FIG. 18B is a partial enlarged view of same. FIGS. 28A and 28B are plan view perspective diagrams showing other examples of the structure of the head 250. FIG. 29 is a cross-sectional diagram taken along line 22-22 in FIGS. 27A and 27B and showing the inner composition of a droplet ejection element of one channel (an ink chamber unit corresponding to one nozzle 251).

As shown in FIG. 27A, the head 250 according to the present embodiment has a structure in which a plurality of ink chamber units (droplet ejection elements) 253 are arranged two-dimensionally in a matrix configuration, each ink chamber unit including a nozzle 251 forming an ink ejection port, and a pressure chamber 252 corresponding to the nozzle 251, and the like, whereby a high density is achieved in the effective nozzle density (projected nozzle density) obtained by projecting (by orthogonal reflection) the nozzles to an alignment in the lengthwise direction of the head (the direction perpendicular to the paper conveyance direction), that is, a small pitch is achieved in the effective nozzle pitch (projected nozzle pitch).

The mode of composing the nozzle row having the length equal to or greater than the full width of the image formation region of the recording medium P in the direction (the main scanning direction, the direction indicated with an arrow M), which is substantially perpendicular to the feed direction of the recording medium P (the sub-scanning direction, the direction indicated with an arrow S) is not limited to the present example. For example, instead of the composition in FIG. 27A, it is possible to adopt a mode in which a line head having a nozzle row of a length corresponding to the full width of the recording medium P is composed by joining together in a staggered configuration short head modules 250′ in which a plurality of nozzles 251 are arranged in a two-dimensional arrangement, as shown in FIG. 28A, or a mode in which head modules 250″ are joined together in an alignment in one row, as shown in FIG. 28B.

Each of the pressure chambers 252 arranged to correspond to the respective nozzles 251 has a substantially square planar shape (see FIGS. 27A and 27B), an outlet port to the nozzle 251 is arranged in one corner on a diagonal of the pressure chamber, and an ink inlet port (supply port) 254 is arranged in the other corner thereof. The shape of the pressure chambers 252 is not limited to that of the present example and various modes are possible in which the planar shape is a quadrilateral shape (rhombic shape, rectangular shape, or the like), a pentagonal shape, a hexagonal shape, or other polygonal shape, or a circular shape, an elliptical shape, or the like.

As shown in FIG. 29, the head 250 has a structure in which a nozzle plate 251A in which the nozzles 251 are formed, a flow channel plate 252P in which flow channels such as pressure chambers 252 and a common flow channel 255, and the like, are formed, and so on, are layered and bonded together.

The flow channel plate 252P is a flow channel forming member which constitutes side wall portions of the pressure chambers 252 and in which a supply port 254 is formed to serve as a restricting part (most constricted portion) of an individual supply channel for guiding the ink to each pressure chamber 252 from the common flow channel 255. For the sake of the description, a simplified view is given in FIG. 29, but the flow channel plate 252P has a structure formed by layering together one or a plurality of substrates.

The nozzle plate 251A and the flow channel plate 252P can be processed into a desired shape by a semiconductor manufacturing process using silicon as a material.

The common flow channel 255 is connected to an ink tank (not shown), which is a base tank that supplies the ink, and the ink supplied from the ink tank is supplied through the common flow channel 255 to the pressure chambers 252.

Piezoelectric actuators 258 each including individual electrodes 257 are bonded to a diaphragm 256, which constitutes a portion of the faces of the pressure chambers 252 (the ceiling face in FIG. 29). The diaphragm 256 in the present embodiment is made of silicon (Si) having a nickel (Ni) conducting layer, which functions as a common electrode 259 corresponding to the lower electrodes of the piezoelectric actuators 258, and serves as a common electrode for the piezoelectric actuators 258 which are arranged so as to correspond to the respective pressure chambers 252. A mode is also possible in which a diaphragm is made from a non-conductive material, such as resin, in which case, a common electrode layer made of a conductive material, such as metal, is formed on the surface of the diaphragm material. Furthermore, the diaphragm which also serves as the common electrode can be made of a metal (conductive material), such as stainless steel (SUS), or the like.

When a drive voltage is applied to the individual electrode 257, the piezoelectric actuator 258 deforms, thereby changing the volume of the corresponding pressure chamber 252. This causes a pressure change which results in the ink in the pressure chamber 252 being ejected from the nozzle 251. When the piezoelectric actuator 258 returns to its original position after the ink ejection, the pressure chamber 252 is replenished with new ink from the common flow channel 255 through the supply port 254.

The high-density nozzle head of the present embodiment is achieved by arranging the plurality of ink chamber units 253 having the above-described structure in a lattice configuration according to a prescribed arrangement pattern in a row direction following the main scanning direction and an oblique column direction having a prescribed non-perpendicular angle θ with respect to the main scanning direction, as shown in FIG. 27B. If the pitch between adjacent nozzles in the sub-scanning direction is taken to be Lₛ, then this matrix arrangement can be treated as equivalent to a configuration where the nozzles 251 are effectively arranged in a single straight line at a uniform pitch of P=Lₛ/tan θ apart in the main scanning direction.

In implementing the present invention, the mode of arrangement of the nozzles 251 in the head 250 is not limited to the embodiments shown in the drawings, and it is possible to adopt various nozzle arrangements. For example, it is possible to use a single line linear nozzle arrangement, such as a V-shaped nozzle arrangement, or a zig-zag shape (W shape, or the like) in which a V-shaped nozzle arrangement is repeated.

### Effects of Present Embodiment

According to the present embodiment, the detection of the malfunctioning nozzle is carried out immediately before the image processing parameter (the non-ejection correction LUT, the density non-uniformity correction LUT, and so on) corresponding to the correction value of the present invention is generated, while the image processing parameter is generated, and immediately before the print JOB.

By carrying out the detection of the malfunctioning nozzle immediately before the image processing parameter (the non-ejection correction LUT, the density non-uniformity correction LUT, and so on) is generated, while the image processing parameter is generated, and immediately before the print JOB, management of the nozzle can be ensured than before. Furthermore, compared to a case where the detection of the malfunctioning nozzle is carried out only one before printing, a possibility that a malfunctioning nozzle, in particular, an unstable malfunctioning nozzle that may enter a state where ink cannot be ejected continuously can be detected increases.

### MODIFICATION EXAMPLES

In the embodiments described above, the inkjet recording apparatus based on the method which forms an image by ejecting and depositing ink droplets directly onto the recording medium P (direct recording method) has been described, but the application of the present invention is not limited to this, and the present invention can also be applied to an image forming apparatus of an intermediate transfer type, which provisionally forms an image (primary image) on an intermediate transfer body, and then performs final image formation by transferring the image onto recording paper in a transfer unit.

### <Device for Causing Relative Movement of Head and Paper>

In the embodiments described above, the example is given in which the recording medium is conveyed with respect to the stationary inkjet heads, but in implementing the present invention, it is also possible to move the heads with respect to a stationary recording medium (image formation receiving medium).

### <Recording Medium>

“Recording medium” is a general term for a medium on which dots are recorded by droplets ejected from an inkjet head, and this includes various terms, such as print medium, recorded medium, image formed medium, image receiving medium, ejection receiving medium, and the like. In implementing the present invention, there are no particular restrictions on the material or shape, or other features, of the recording medium, and it is possible to employ various different media, irrespective of their material or shape, such as continuous paper, cut paper, seal paper, OHP sheets or other resin sheets, film, cloth, nonwoven cloth, a printed substrate on which a wiring pattern, or the like, is formed, or a rubber sheet.

### <Ejection Method>

The device which generates pressure (ejection energy) for ejection in order to eject droplets from the nozzles of the inkjet head is not limited to a piezoelectric actuator (piezoelectric element). Apart from a piezoelectric element, it is also possible to employ pressure generating elements (ejection energy generating elements) of various kinds, such as a heater (heating element) in a thermal method (a method which ejects ink by using the pressure produced by film boiling caused by heat from the heater), or various actuators based on other methods. A corresponding energy generating element is arranged in the flow channel structure in accordance with the ejection method of the head.

### APPARATUS APPLICATION EXAMPLES

In each of the embodiments described above, application to the inkjet recording apparatus for graphic printing has been described, but the scope of application of the present invention is not limited to this example. For example, the present invention can also be applied widely to inkjet systems which obtain various shapes or patterns using liquid function material, such as a wire printing apparatus which forms an image of a wire pattern for an electronic circuit, manufacturing apparatuses for various devices, a resist printing apparatus which uses resin liquid as a functional liquid for ejection, a color filter manufacturing apparatus, a fine structure forming apparatus for forming a fine structure using a material for material deposition, or the like.

Although in each of the embodiments described above, an inkjet recording apparatus has been described as an example of the printer 12, the present invention can be applied to various image recording apparatuses such as a thermal transfer recording apparatus that includes a recording head where a thermal element serves as a recording element and an LED electrophotographic printer that includes a recording head where an LED element serves as a recording element.

Although the non-ejection correction LUT and the density non-uniformity correction LUT have been described as examples of the image processing parameter corresponding to the correction value of the present invention in each of the embodiments described above, a correction value to be used to correct image non-uniformity resulting from the recording characteristics of each ink nozzle (recording element) may be generated, and the detection of the malfunctioning nozzle is carried out immediately before and while this correction value is generated.

Although the malfunctioning nozzle sensing test chart 56 is outputted simultaneously with the non-uniform streak correction test chart 55 and the density non-uniformity correction test chart 70 immediately before and while the non-ejection correction LUT 46 and the density non-uniformity correction LUT 64 are generated to detect a malfunctioning nozzle in each of the embodiments described above, the detection of the malfunctioning nozzle may be carried out by analyzing a read result of each of the correction test charts.

Although the malfunctioning nozzle information registration processing is carried out immediately before or while the image processing parameter such as the non-ejection correction LUT 46 or the density non-uniformity correction LUT 64 is generated in each of the embodiments described above, similar malfunctioning nozzle information registration processing may also be carried out after the image processing parameter is generated. Through this, the nozzle management can be ensured more reliably.

Although the detection of the malfunctioning nozzle is carried out immediately before the print JOB (before recording the image) in each of the embodiments described above, the detection of the malfunctioning nozzle may further be carried out after the print JOB is completed or during the print JOB (for example, after 50 sheets out of 100 sheets have been printed). In addition, the detection of the malfunctioning nozzle may be carried out a plurality of times in a period after the image processing parameter is acquired to immediately before the print JOB.

Although the in-line sensor 29 to read the various test charts is provided in the printing system (the printer 12) in each of the embodiments described above, various sensors to read the test charts may be provided separately from the printing system (the printer). In this case, a read result of a test chart read by an external sensor is inputted to the printing system (the PC 14), and based on this read result, the non-ejection correction LUT generation unit 52 and the density non-uniformity correction LUT generation unit 67 generate various LUTs.

Although the printer 12 and the PC 14 are separate entities in each of the embodiments described above, a control circuit having a function similar to that of the PC 14 may be provided in the printer 12. Further, although the output density (output) of each nozzle is corrected through the signal conversion processing (the image processing) by the nozzle ejection correction processing unit in each of the embodiments described above, in place of the image processing, a drive signal of each nozzle may be corrected.

It should be noted that the present invention is not limited to the embodiments described thus far, and various modifications can be made by a person of ordinary skill in the art within the technical spirit of the present invention. For example, at least any two of the embodiments described above may be combined as appropriate.

What is claimed is:

1. An image recording apparatus, comprising:
an image recording device that records an image on a recording medium with a recording head having a plurality of recording elements while moving the recording head and the recording medium relative to each other;
a correction value generation device that acquires characteristic information indicative of recording characteristics of the plurality of recording elements to generate, based on the characteristic information, a correction value for correcting an output of recording elements that are included in the plurality of recording elements and are to be used to correct non-uniformity in the image resulting from the recording characteristics;
a first defective recording element detection device that detects a defective recording element among the plurality of recording elements immediately before the correction value is generated by the correction value generation device;
a second defective recording element detection device that carries out detection of the defective recording element in a period after the detection of the defective recording element by the first defective recording element detection device and while the correction value is being generated by the correction value generation device;
a third defective recording element detection device that carries out detection of the defective recording element in a period after the detection of the defective recording element by the second defective recording element detection device and at least before the image is recorded;
a stopping device that, when the defective recording elements are detected respectively by the first defective recording element detection device, the second defective recording element detection device, and the third defective recording element detection device, causes the output from the detective recording elements to stop; and
an output correction device that corrects the output of the recording elements other than the defective recording elements based on the correction value.

2. The image recording apparatus according to claim 1, wherein, when the defective recording element is detected by the first defective recording element detection device, the stopping device causes the output from the defective recording element to stop before the characteristic information is acquired by the correction value generation device.

3. The image recording apparatus according to claim 1, further comprising:
a memory device that stores defective recording element information that pertains to the defective recording elements detected respectively by the first defective recording element detection device, the second defective recording element detection device, and the third defective recording element detection device,
wherein the stopping device causes the output from the defective recording element to stop based on the defective recording element information stored in the memory device.

4. The image recording apparatus according to claim 3, wherein the memory device separately stores defective recording element information pieces that pertain to the respective defective recording elements detected respectively by the first defective recording element detection device, the second defective recording element detection device, and the third defective recording element detection device.

5. The image recording apparatus according to claim 3, further comprising:
a first information deletion device that, when a new instance of the correction value is to be generated by the correction value generation device, deletes, from the memory device, the defective recording element information on the defective recording elements detected by the first and second defective recording element detection devices when generating a previous instance of the correction value.

6. The image recording apparatus according to claim 3, wherein, each time a new instance of the defective recording element is detected by the first and second defective recording element detection devices as a new instance of the correction value is generated by the correction value generation device, the memory device additionally stores the defective recording element information that pertains to the defective recording element.

7. The image recording apparatus according to claim 6, further comprising:
a count device that counts the number of the defective recording elements based on the defective recording element information stored in the memory device; and
a warning display device that, when the number of the defective recording elements counted by the count device reaches a predetermined number, carries out a warning display indicating that the number of the detective recording elements counted by the count device has reached the predetermined number.

8. The image recording apparatus according to claim 7, further comprising:
a second information deletion device that, when a predetermined operation to execute detection of the defective recording element is carried out after the warning display by the warning display device, deletes, from the memory device, the defective recording element information on the defective recording elements detected by the first and second defective recording element detection devices.

9. The image recording apparatus according to claim 1, wherein:
the correction value generation device generates a plurality of types of the correction values to respectively correct a plurality of types of the non-uniformity;
the first defective recording element detection device carries out detection of the defective recording element immediately before each of the plurality of types of the correction values is generated by the correction value generation device; and
the second defective recording element detection device carries out detection of the defective recording element while each of the plurality of types of the correction values is being generated by the correction value generation device.

10. The image recording apparatus according to claim 3, wherein:
the correction value generation device generates the correction values respectively for a plurality of image recording conditions when an image is recorded on the recording medium;
the memory device stores the correction values for the image recording conditions generated by the correction value generation device and the defective recording element information on the defective recording elements for the image recording conditions detected by the first and second defective recording element detection devices as the correction values are generated, the correction values and the defective recording element information being associated with each other;
the memory device includes an image recording condition selection device that selects an image recording condition;
the stopping device causes the output from the defective recording element to stop based on the defective recording element information in the memory device corresponding to the image recording condition selected by the image recording condition selection device; and
the output correction device corrects the output of the recording elements other than the defective recording element based on the correction value in the memory device corresponding to the image recording condition.

11. The image recording apparatus according to claim 10, wherein:
the image recording condition selection device can select a plurality of the image recording conditions;
the output correction device corrects the output of the recording elements other than the defective recording element based on the plurality of correction values that respectively correspond to the plurality of image recording conditions selected by the image recording condition selection device; and
the stopping device causes the output from the defective recording element to stop based on a combination of the plurality of pieces of defective recording element information that respectively correspond to the plurality of image recording conditions selected by the image recording condition selection device.

12. The image recording apparatus according to claim 1, wherein the correction value generation device acquires, as the characteristic information, a read result of a first test chart that is recorded by the recording elements other than the recording elements determined as pseudo-defective recording elements in the recording head and generates a first correction value based on the read result of the first test chart to correct a non-uniform streak in the image resulting from the defective recording elements.

13. The image recording apparatus according to claim 1, wherein the correction value generation device acquires, as the characteristic information, a read result of a second test chart that is recorded by the recording head and that indicates recording density for each of the plurality of recording elements and generates a second correction value based on the read result of the second test chart to correct density non-uniformity in the image resulting from the recording characteristics of the plurality of recording elements.

14. The image recording apparatus according to claim 1, wherein the first defective recording element detection device, the second defective recording element detection device, and the third defective recording element detection device carry out detection of the defective recording elements based on a read result of a third test chart that is configured of a line pattern recorded for each of the plurality of recording elements.

15. The image recording apparatus according to claim 1, wherein:
the recording element is a nozzle that ejects a droplet; and
the defective recording element is a non-ejecting nozzle that cannot be used to record the image.

16. The image recording apparatus according to claim 1, wherein the recording head is a head of a single-pass type that records the image with a relative single movement with respect to the recording medium.

17. An image recording method for recording an image on a recording medium with a recording head having a plurality of recording elements while moving the recording head and the recording medium relative to each other, the method comprising:
a correction value generation step of acquiring characteristic information indicative of recording characteristics of the plurality of recording elements to generate, based on the characteristic information, a correction value for correcting an output of recording elements that are included in the plurality of recording elements and are to be used to correct non-uniformity in the image resulting from the recording characteristics;
a first defective recording element detection step of detecting a defective recording element among the plurality of recording elements immediately before the correction value is generated in the correction value generation step;
a second defective recording element detection step of carrying out detection of the defective recording element in a period after the detection of the defective recording element in the first defective recording element detection step and while the correction value is being generated in the correction value generation step;
a third defective recording element detection step of carrying out detection of the defective recording element in a period after the detection of the defective recording element in the second defective recording element detection step and at least before the image is recorded;
an output stopping step of, when the defective recording elements are detected respectively in the first defective recording element detection step, the second defective recording element detection step, and the third defective recording element detection step, causing the output from the detective recording elements to stop; and
an output correction step of correcting the output of the recording elements other than the defective recording elements based on the correction value.
